(19) United States
(12) Patent Application Publication
(10) Pub. No.: US 2025/0343037 A1
(43) Pub. Date: Nov. 6, 2025

(54) MICRO-IONIZER FOR MASS SPECTROMETRY

(71) Applicant: Carnegie Mellon University, Pittsburgh, PA (US)

(72) Inventors: Mark E. BIER, Pittsburgh, PA (US); Nicole C. AUVIL, Rocky River, OH (US)

(73) Assignee: Carnegie Mellon University, Pittsburgh, PA (US)

(21) Appl. No.: 18/869,110

(22) PCT Filed: May 26, 2023
(86) PCT No.: PCT/US2023/023685

§ 371 Date: Nov. 25, 2024

Related U.S. Application Data
(60) Provisional application No. 63/345,931, filed on May 26, 2022.

(51) Int. Cl. H01J 49/16; H01J 49/00

(52) U.S. Cl. CPC H01J 49/168; H01J 49/0004

(57) ABSTRACT

A needle for mass spectrometry having a solid shaft and a first end with a tip having a radius of curvature of less than 1500 nm, wherein the tip is distal from a second end of the needle, wherein the second end is configured to accept an electrical potential, and wherein the tip provides an ionization region when the electrical potential is applied. Methods of manufacturing a needle having a radius of curvature of less than 1500 nm. Methods and systems including at least one needle of the present disclosure for qualitative and/or quantitative analysis.

### CROSS REFERENCE TO RELATED APPLICATIONS

This application claims priority to and the benefit of U.S. Provisional Patent Application No. 63/345,931, filed on May 26, 2022, entitled MINIATURE IONIZER FOR MASS SPECTROMETRY, which is expressly incorporated herein by reference in its entirety.

### FIELD OF THE INVENTION

This disclosure generally relates to the field of mass spectrometry and more specifically to devices, systems, and methods for creating a corona discharge to ionize analytes that may be measured using a mass spectrometer.

### BACKGROUND

A corona discharge is a release of electrical energy that occurs when the air surrounding a highly charged conductor undergoes dielectric breakdown and becomes ionized. Corona discharges may be generated to create an ionization region to ionize analytes in the gaseous phase. A needle having a point may be charged to create an ionization region at the tip and ionize gas phase analytes, which may then be analyzed using mass spectrometry.

### BRIEF SUMMARY

The present disclosure provides a needle for mass spectrometry having a solid shaft and a first end with a tip having a radius of curvature of less than 1500 nm, wherein the tip is distal from a second end of the needle, wherein the second end is configured to accept an electrical potential, and wherein the tip provides an ionization region when the electrical potential is applied.

The present disclosure provides a method of manufacturing a needle having a tip with a radius of curvature of 1 nm to 1500 nm, wherein the method includes inserting an end of a metal wire through a center of an annular ring and into a crucible containing a salt solution, and applying a voltage, wherein the center of the annular ring includes a liquid lamella.

The present disclosure further provides a method for detecting at least one analyte, the method including: providing a sample, providing an electrical potential to any of the needles according to the present disclosure, wherein the electrical potential causes an ionization region at the tip of the needle to convert the at least one analyte to at least one gaseous analyte ion; collecting the at least one gaseous analyte ion; and analyzing the at least one gaseous analyte ion using a mass spectrometer, wherein analyzing includes a qualitative and/or quantitative analysis.

The present disclosure provides open and enclosed systems for detection of at least one analyte.

### DESCRIPTION OF THE DRAWINGS

It is to be understood that both the foregoing summary and the following drawings and detailed description may be exemplary and may not be restrictive of the aspects of the present disclosure as claimed. Certain details may be set forth in order to provide a better understanding of various features, aspects, and advantages of the invention. However, one skilled in the art will understand that these features, aspects, and advantages may be practiced without these details. In other instances, well-known structures, methods, and/or processes associated with methods of practicing the various features, aspects, and advantages may not be shown or described in detail to avoid unnecessarily obscuring descriptions of other details of the present disclosure.

The present disclosure may be better understood by reference to the accompanying drawing sheets, in which:

FIG. 1 is a scanning electron microscopy image of a conventional needle having a 14,000 nm radius of curvature at 300× magnification.

FIG. 2 is a scanning electron microscopy image of a conventional needle at 300× magnification as disclosed in (Habib et al., 2013).

FIG. 3A is a scanning electron microscopy image of the needle as shown in FIG. 2 at 1000× magnification, wherein FIG. 3B is a scanning electron microscopy image of the same needle having an actual radius of curvature of 1537 nm, wherein FIG. 3C is a scanning electron microscopy image of the same needle with a representation of a reported radius of curvature of 350 nm.

FIG. 4 is a scanning electron microscopy image of a needle of the present disclosure at 300× magnification having a radius of curvature of 18 nm.

FIGS. 5A & 5B are illustrations of a needle of the present disclosure.

FIG. 6 is a schematic diagram of a system according to the present disclosure.

FIG. 7 is a schematic diagram of a system according to the present disclosure.

FIG. 8 is a schematic diagram of an enclosed system according to the present disclosure.

FIG. 9 is a schematic diagram of an enclosed system according to the present disclosure.

FIG. 10 is a schematic diagram of an enclosed system having two needles according to the present disclosure.

FIG. 11 is a schematic diagram of an enclosed system having a first system with two needles and a second system in a mass spectrometer interface according to present disclosure.

FIG. 12 is a schematic diagram of a serial discharge system having at least two needles in both serial and parallel configurations according to the present disclosure.

FIG. 13 is a schematic diagram of a serial discharge system having at least two needles according to the present disclosure.

FIG. 14 is an illustration of a method of manufacturing a needle of the present disclosure.

FIG. 15 is a diagram of geometric parameters of a needle tip of the present disclosure.

FIG. 16 is a graph of Nanoelectrode Ambient Ionization (NAI) geometry optimizations of intensity (a.u.) vs. distance (mm) from the needle and mass spectrometer inlet according to the present disclosure.

FIG. 17 is a graph of Nanoelectrode Ambient Ionization (NAI) geometry optimization of intensity (a.u.) vs. distance (mm) from the sample and needle.

FIG. 18 is a graph of Nanoelectrode Ambient Ionization (NAI) geometry optimization of intensity (a.u.) vs. capillary temperature (° C.).

FIG. 19A is a scanning electron microscopy image of the conventional needle of FIG. 2 at 1000× magnification, wherein the radius of curvature is 1537 nm.

FIG. 19B is a scanning electron microscopy image of the same needle as shown in FIG. 19A at 1000× magnification after a voltage titration of approximately 0 V to 2000 V, wherein the radius of curvature is 9,640 nm.

FIG. 20A is a scanning electron microscopy image of the conventional needle of FIG. 1 at 1000× magnification.

FIG. 20B is a scanning electron microscopy image of the same needle as shown in FIG. 20A at 1000× magnification after a voltage titration of approximately 0 V to 2000 V, wherein the radius of curvature is 10,360 nm.

FIG. 21A is a scanning electron microscopy image of a tungsten needle of the present disclosure at 1000× magnification having a 15 nm radius of curvature, wherein FIG. 21B is a scanning electron microscopy image of the same needle at 1000× magnification having a 428 nm radius of curvature after 20 hours of continuous use with a voltage of 1000 V in an open system of the present disclosure.

FIG. 22A is a scanning electron microscopy image of a tungsten needle of the present disclosure at 1000× magnification having a radius of curvature of 16 nm, wherein FIG. 22B is a scanning electron microscopy image of the same needle at 1000× magnification having a 500 nm radius of curvature after 20 hours of continuous use with a voltage of 1200 V in an enclosed system of the present disclosure.

FIG. 23A is a scanning electron microscopy image of a needle of the present disclosure at 1000× magnification having a radius of curvature of 13 nm, wherein FIG. 23B is a scanning electron microscopy image of the same needle at 1000× magnification having a 215 nm radius of curvature after a voltage titration of approximately 0 V to 2000 V in an open system of the present disclosure.

FIG. 24A is a scanning electron microscopy image of a needle of the present disclosure at 1000× magnification having a radius of curvature of 14 nm, wherein FIG. 24B is a scanning electron microscopy image of the same needle at 1000× magnification having a radius of curvature of 51 nm after a voltage titration of approximately 0 V to 2000 V in an enclosed system of the present disclosure.

FIG. 25 is a scanning electron microscopy image of a needle of the present disclosure at 40000× magnification having at least one whisker according to the present disclosure.

FIGS. 26A, 26C, and 26E are scanning electron microscopy images of a needle of the present disclosure at 40,000×, wherein FIGS. 26B, 26D, and 26F are scanning electron microscopy images of the same needle having at least one whisker after 20 hours of continuous use with a voltage of 1075 V at 40,000×, 40,000×, and 73,360× magnification, respectively.

FIG. 27 is a graph of signal onset voltage of a needle of the present disclosure having a radius of curvature of 24 nm without at least one whisker (circle) and a needle of the present disclosure having a radius of curvature of 336 nm with at least one whisker (square).

FIG. 28 is a graph of signal onset voltage of a needle of the present disclosure having a radius of curvature of 48 nm without at least one whisker (diamond) and a needle of the present disclosure having a radius of curvature of 55 nm with at least one whisker (triangle).

FIG. 29 is an illustration of a system having two needles of the present disclosure for surface analysis and imaging according to the present disclosure.

FIG. 30 is an illustration of a system having a needle of the present disclosure for surface analysis and imaging according to the present disclosure.

FIG. 31 is an illustration of an enclosed system for qualitative and/or qualitative analysis of volatile or semi-volatile organic molecules of a sample according to the present disclosure.

FIG. 32 is a mass spectrum of a sample of ibuprofen (2-(4-isobutylphenyl) propanoic acid) analyzed by the devices, methods, and systems of the present disclosure.

FIG. 33 is a mass spectrum of a sample of albuterol sulfate analyzed by the devices, methods, and systems of the present disclosure.

FIG. 34 is a mass spectrum of a sample of a surface of a thermal receipt paper analyzed by the devices, methods, and systems of the present disclosure.

FIG. 35 is a mass spectrum of a sample of peppermint essential oil analyzed by the devices, methods, and systems of the present disclosure.

FIG. 36 is a mass spectrum of a sample of human skin analyzed analyzed by the devices, methods, and systems of the present disclosure for the presence of caffeine after and before drinking coffee.

FIG. 37 is a mass spectrum of a sample of paper currency analyzed by the devices, methods, and systems of the present disclosure for the presence of cocaine.

FIG. 38 is a mass spectrum of a sample of e-cigarette aerosol analyzed by the devices, methods, and systems of the present disclosure.

FIG. 39 is a mass spectrum of a sample of background air analyzed by the devices, methods, and systems of the present disclosure.

FIGS. 40A-E are total ion chromatograms of voltage titration experiments of needles of the present disclosure having a radius of curvature of 13 nm, 18 nm, 32 nm, 42 nm, and 52 nm, respectively, wherein the voltage is increased over time from approximately 0 V to 2000 V, and wherein the signal reached a stable voltage at 1000V for every needle.

FIGS. 41A-E are total ion chromatograms of a second voltage titration of needles of FIGS. 40 A-E having a radius of curvature of 215 nm, 62 nm, 65 nm, 197 nm, and 317 nm, respectively, after the second voltage titration, wherein the voltage is increased over time from approximately 0 V to 2000 V, and wherein the dashed box indicates the voltage at which a stable signal was reached.

FIG. 42A is a total ion chromatogram of voltage titration experiments for a needle of the present disclosure placed coaxially to the inlet of the mass spectrometer.

FIG. 42B is a total ion chromatogram of voltage titration experiments for a needle of the present disclosure placed perpendicular to the inlet of the mass spectrometer.

FIG. 43A is a total ion chromatogram of voltage titration experiments for the needle of FIG. 2.

FIG. 43B is a total ion chromatogram of voltage titration experiments for the needle of FIG. 1.

FIGS. 44A-D shows results of voltage titration testing using 400, 200, 22, and 1 MΩ, respectively, in an open system, wherein increasing voltage was applied over time from approximately 0 V to 2000 V, and wherein a stable signal is reached at 1000V.

FIG. 45 includes total ion chromatograms of needles of the present disclosure having a radius of curvature of 13, 18, 32, 42, and 52 (panels A-E, respectively), and total ion chromatograms of used needles of the present disclosure having a radius of curvature of 65, 215, and 317 nm (panels F-H, respectively), including the prior art needle of FIG. 2 (panel I), the ACPI needle of FIG. 1 (panel J), and a 14 nm ROC needle of the present disclosure in an enclosed system (panel K).

FIG. 46A is a total ion chromatogram of an open system of the present disclosure, wherein a signal was continuously collected for 20 hours.

FIG. 46B is a total ion chromatogram of an enclosed system of the present disclosure, wherein a signal was continuously collected for 20 hours.

FIG. 47A is a mass spectrum of standard samples of perillic aldehyde and background air analyzed by a needle of the present disclosure according to methods and systems of the present disclosure.

FIG. 47B is a mass spectrum of one drop of perillic aldehyde on gauze analyzed by a needle of the present disclosure according to methods and systems of the present disclosure.

FIG. 48 is a system of the present disclosure including at least two needle tips of the present disclosure on a plate.

### DETAILED DESCRIPTION

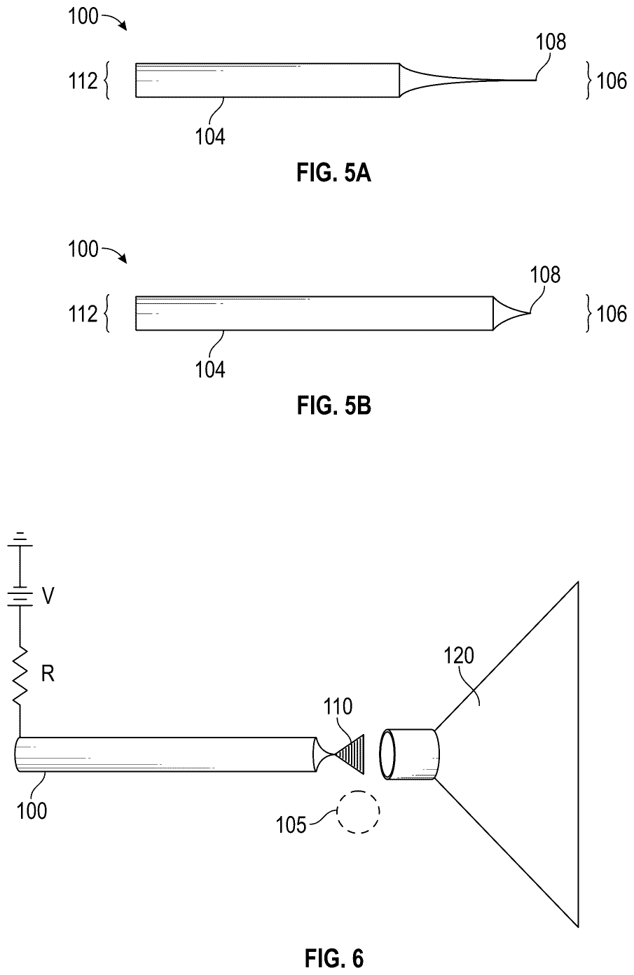

The present disclosure provides a needle 100 (FIGS. 5A & 5B) capable of producing a corona discharge or ionization region when an electrical potential or voltage is applied. The needle 100 may include a solid shaft 104 and a first end 106 with a tip 108. The tip 108 may be distal from a second end 112 of the needle 100. The second end 112 may be configured to accept an electrical potential, wherein a voltage may be applied to the second end 112. Once an electrical potential is applied, the tip 108 may provide an ionization region. Like numbers refer to like elements throughout.

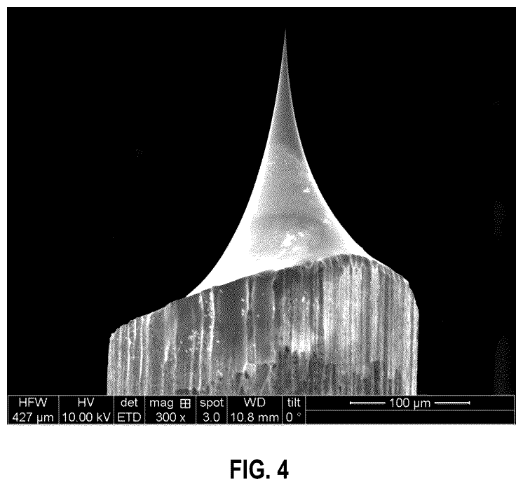

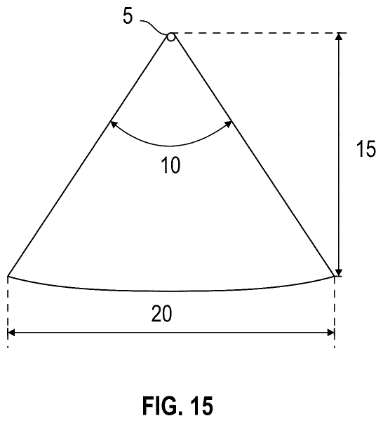

The tip of the needle of the present disclosure may be formed as a cone having concave sides (FIG. 4). While a tip of the needle formed as a cone having concave sides is described, other shapes are possible and within the scope of the present disclosure. The tip of the needle of the present disclosure may have a radius of curvature 5 (ROC), cone height 15, cone angle 10, and a cone base 20 (FIG. 15). The tip may have a radius of curvature of 1 nm to 1500 nm. The radius of curvature may be at least 1 nm, such as, without limitation, 2, 5, 10, 15, 20, 25, 30, 35, 40, 45, 50, 75, 100, 150, 200, 250, 300, 350, 500, 1000, and 1500 nm. The radius of curvature may be no more than 1500 nm, such as, without limitation, 1250, 1000, 500, 350, 300, 250, 200, 150, 100, 75, 50, 45, 40, 35, 30, 25, 20, 15, 10, 5, 2, and 1 nm. Any combination of lower and upper limits may define the radius of curvature, such as 1 nm to 1500 nm, including, without limitation, 1 nm to 20 nm, 20 nm to 50 nm, 50 nm to 100 nm, 100 nm to 300 nm, 300 nm to 500 nm, 500 nm to 1000 nm, and 1000 nm to 1500 nm.

While a radius of curvature of 1 nm to 1500 nm has been described, a radius of curvature of less than 1 nm or greater than 1500 nm is possible and within the scope of the present disclosure. For example, a tip having a radius of curvature of a single atom or molecule may provide an ionization region once an electrical potential is applied to the needle.

The tip of the needle may be tapered. The tip of the needle may have a length of 0.001 cm to 2.5 cm, wherein length of the tip may be defined as the distance from an apex of the tip to the cone base. The length of the tip may be the length of the cone height 15. The length of the tip may be at least 0.001 cm, such as, without limitation, 0.001, 0.005, 0.01, 0.05, 0.10, 0.50, 1.0, 1.25, 1.50, 1.75, 2.0, and 2.5 cm. The length of the tip may be no more than 2.5 cm, such as, without limitation, 2.0, 1.75, 1.50, 1.25, 1.0, 0.50, 0.10, 0.05, 0.01, 0.005, and 0.001 cm. Any combination of lower and upper limits may define the length of the tip, such as 0.001 cm to 2.5 cm, including, without limitation, 0.001 cm to 0.005 cm, 0.005 cm to 0.01 cm, 0.01 cm to 0.10 cm, 0.10 cm to 0.50 cm, 0.50 cm to 1.0 cm, 1.0 cm to 1.50 cm, 1.50 cm to 2.0 cm, and 2.0 cm to 2.50 cm. While a tip length of 0.001 cm to 2.5 cm has been described, any tip length capable of producing an ionization region at the tip of the needle and a needle having a radius of curvature of 1 nm to 1500 nm is possible and within the scope of the present disclosure.

The tip may have a cone height 15 of 50 microns to 10,0000 microns. The cone height 15 may be at least 50 microns, such as, without limitation, 50, 100, 250, 500, 1000, 2000, 4000, 6000, 7000, 8000, and 10,0000 microns. The cone height 15 may be no more than 10,000 microns, such as, without limitation, 8000, 6000, 4000, 2000, 1000, 500, 250, 100, and 50 microns. Any combination of lower and upper limits may define the cone height 15 of the tip, such as 50 microns to 10,000 microns, including, without limitation, 50 microns to 100 microns, 100 microns to 250 microns, 250microns to 500 microns, 500 microns to 1000 microns, 1000 microns to 2000 microns, 2000 microns to 4000 microns, 4000 microns to 6000 microns, 6000 microns to 8000 microns, and 8000 microns to 10,000 microns. While a cone height of 50 microns to 10,000 microns has been described, any cone height capable of producing an ionization region at the tip of the needle and a needle having a radius of curvature of 1 nm to 1500 nm is possible and within the scope of the present disclosure.

The tip may have a cone angle 10 of 1° to 90°. The cone angle 10 may be at least 1°, such as, without limitation, 3, 5, 10, 15, 20, 25, 30, 35, 40, 45, 50, 55, 60, 65, 70, 75, 80, 85, and 90°. The cone angle 10 may be no more than 90°, such as, without limitation, 85, 80, 75, 70, 65, 60, 55, 50, 45, 40, 35, 30, 25, 20, 15, 10, 5, 3 and 1°. Any combination of lower and upper limits may define the cone angle 10, such as 1° to 90°, including, without limitation, 1° to 3°, 3° to 5°, 5° to 10°, 10° to 15°, 15° to 20°, 20° to 25°, 25° to 30°, 30° to 35°, 35° to 40°, 40° to 45°, 45° to 50°, 50° to 55°, 55° to 60°, 60° to 70°, 70° to 80°, and 80° to 90°. While a cone angle of 1° to 90° has been described, any cone angle capable of producing an ionization region at the tip of the needle and a needle having a radius of curvature of 1 nm to 1500 nm is possible and within the scope of the present disclosure.

The tip may have a cone base 20 of 0.1 mm to 3 mm. The cone base may be at least 0.1 mm, such as, without limitation, 0.1, 0.2, 0.3, 0.4, 0.5, 0.6, 0.7, 0.8, 0.9, 1.0, 1.25, 1.50, 1.75, 2.0, 2.25, 2.50, 2.75, and 3.0 mm. The cone base 20 may be no more than 3 mm, such as, without limitation, 2.75, 2.50, 2.25, 2.0, 1.75, 1.50, 1.25, 1.0, 0.9, 0.8, 0.7, 0.6, 0.5, 0.4, 0.3, 0.2, and 0.1 mm. Any combination of lower and upper limits may define the cone base 20 of the tip, such as 0.1 mm to 3 mm, including, without limitation, 0.1 mm to 0.5 mm, 0.5 mm to 1.0 mm, 1.0 mm to 1.5 mm, 1.5 mm to 2.0 mm, 2.0 mm to 2.5 mm, and 2.5 mm to 3.0 mm. While a cone base of 0.1 mm to 3 mm has been described, any cone base capable of producing an ionization region at the tip of the needle and a needle having a radius of curvature of 1 nm to 1500 nm is possible and within the scope of the present disclosure.

The tip may have a linear, parabolic, hyperbolic, or exponential shape. While linear, parabolic, hyperbolic, exponential, or curved shapes have been described, other shapes are possible and within the scope of the present disclosure.

The solid shaft of the needle may have a diameter of 0.1 mm to 3 mm. The diameter may be at least 0.1 mm, such as, without limitation, 0.1, 0.2, 0.3, 0.4, 0.5, 0.6, 0.7, 0.8, 0.9, 1.0, 1.25, 1.50, 1.75, 2.0, 2.25, 2.50, 2.75, and 3.0 mm. The diameter may be no more than 3 mm, such as, without limitation, 2.75, 2.50, 2.25, 2.0, 1.75, 1.50, 1.25, 1.0, 0.9, 0.8, 0.7, 0.6, 0.5, 0.4, 0.3, 0.2, and 0.1 mm. Any combination of lower and upper limits may define the diameter of the solid shaft, such as 0.1 mm to 3 mm, including, without limitation, 0.1 mm to 0.5 mm, 0.5 mm to 1.0 mm, 1.0 mm to 1.5 mm, 1.5 mm to 2.0 mm, 2.0 mm to 2.5 mm, and 2.5 mm to 3.0 mm. While a solid shaft having a diameter of 0.1 mm to 3 mm has been described, any diameter capable of producing an ionization region at the tip of the needle and a needle having a radius of curvature of 1 nm to 1500 nm is possible and within the scope of the present disclosure.

The solid shaft of the needle may have a length of 0 to 10 m. A needle having a shaft length of 0 may consist of a needle tip, wherein the needle does not include a shaft. The shaft length may be 0 to 1 cm, 0 to 2 cm, 0 to 3 cm, 0 to 4 cm, 0 to 5 cm, 0 to 100 cm, 0 to 1 m, 0 to 5 m, 1 cm to 2 cm, 1 cm to 3 cm, 1 cm to 4 cm, 1 cm to 5 cm, 1 cm to 10 m, and the like. While a needle having a solid shaft of 0 to 10 m has been described, any shaft length capable of producing an ionization region at the tip of the needle and a needle having a radius of curvature of 1 nm to 1500 nm is possible and within the scope of the present disclosure.

The needle of the present disclosure may have an aspect ratio of 2:1 to 1:50, wherein the aspect ratio includes a ratio of the solid shaft diameter to the cone height of the tip. The aspect ratio may be at least 2:1, such as, without limitation, 2:1, 1:1, 1:2, 1:3, 1:4, 1:5, 1:6, 1:7, 1:8, 1:9, 1:10, 1:25, and 1:50. The aspect ratio may be no more than 1:50, such as, without limitation, 1:25, 1:10, 1:9, 1:8, 1:7, 1:6, 1:5, 1:4, 1:3, 1:2, 1:1, and 2:1. Any combination of lower and upper limits may define the aspect ratio, such as 2:1 to 1:1, 1:1 to 1:2, 1:2 to 1:3, 1:3 to 1:4, 1:4 to 1:5, 1:5 to 1:6, 1:6 to 1:7, 1:7 to 1:8, 1:8 to 1:9, and 1:9 to 1:10, 1:10 to 1:25, and 1:25 to 1:50. While a needle having an aspect ratio of 2:1 to 1:50 has been described, any aspect ratio capable of producing an ionization region at the tip of the needle and a needle having a radius of curvature of 1 nm to 1500 nm is possible and within the scope of the present disclosure.

The needle of the present disclosure may include a metal material, including, but not limited to, tungsten, gold, platinum, titanium, stainless-steel, and the like. The needle may include a conductive non-metal material, including, but not limited to, a ceramic needle coated with metal, a conductive ceramic material with a matrix of a metal within the ceramic, a mixture of a material with a conductive metal, and the like. The needle may include conductive polymeric materials. While metal and non-metal materials have been described, any material capable of accepting an electrical potential and creating an ionization region at the tip of the needle is possible and within the scope of the present disclosure.

An electrical potential, such as a voltage, may be applied to the needle of the present disclosure. The needle may emit electrical energy at the tip of the needle, wherein the electrical energy may create an ionization region. The electrical potential may be at least 0.1 kV, such as, without limitation 0.2 kV, 0.3 kV, 0.4 KV, 0.5 kV, 1.0 kV, 1.5 kV, 2.0 kV, 2.5 kV, 5 kV, 10 kV, 15 kV, and 20 kV. The electrical may be no more than 20 kV, such as, without limitation 15 kV, 10 kV, 5 kV, 2.5 kV, 2.0 kV, 1.5 kV, 1.0 kV, 0.5 kV, 0.4 KV, 0.3 kV, 0.2 kV, and no more than 0.1 kV. Any combination of lower and upper limits may define the electrical potential, such as 0.1 kV to 2.5 kV, including, without limitation, 0.1 kV to 0.5 kV, 0.5 kV to 1.0 kV, 1.0 kV to 1.5 kV, 1.5 kV to 2.0 kV, 2.0 kV to 2.5 kV, 2.5 kV to 5 kV, 5 kV to 10 kV, 10 kV to 15 kV, and 15 kV to 20 kV. While an electrical potential of 0.1 kV to 20 kV has been described, any electrical potential capable of producing an ionization region at the tip of the needle is possible any within the scope of the present disclosure.

Generally, a needle having a smaller radius of curvature may require a lower voltage to produce an ionization region compared to a needle having a larger radius of curvature. A needle having a smaller radius of curvature may produce less heat compared to a needle having a larger radius of curvature. A needle having a smaller radius of curvature may generate a smaller ionization region compared to a needle having a larger radius of curvature. The smaller ionization region may provide improved spatial resolution. A needle requiring a lower voltage may be used, as the needle may lower energy usage, decrease risk of injury, as a needle having a radius of curvature of 100 nm or less may not puncture human skin, decrease risk of arcing to the instrument, and provide the potential for portable instrumentation due to a decrease in weight and power requirements.

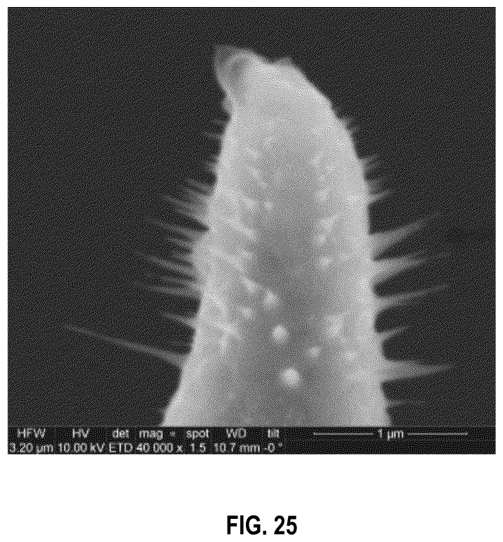

The needle of the present disclosure may include at least one whisker (FIG. 25). As used herein, a whisker may refer to any protrusion from the tip of the needle as a result of a voltage being applied to the needle. The at least one whisker may be reproducible from needles having a radius of curvature of 1 nm to 1500 nm. A needle having at least one whisker may have a lower signal onset voltage compared to the signal onset voltage of a needle without at least one whisker.

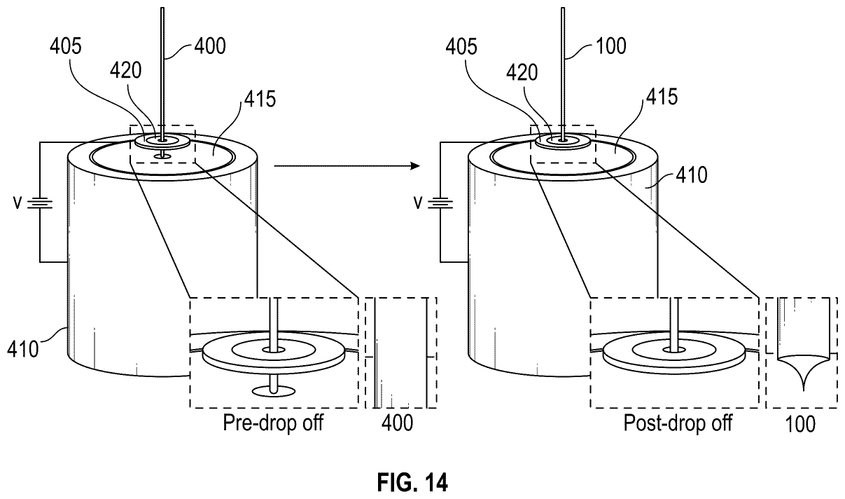

The present disclosure provides a method of manufacturing a needle as described herein. The method may manufacture a needle having a tip with a radius of curvature of 1 nm to 1500 nm. The method may include inserting an end of a metal wire 400 through a center of a conductive annular ring 405 and into a crucible 410 containing a salt solution 415 (FIG. 14). The metal wire may include a metal material, including, but not limited to, tungsten, gold, platinum, titanium, stainless-steel, and the like. The center of the annular ring 405 may include a liquid lamella 420. The annular ring 405 may include any metal material capable of holding a liquid lamella 420 (FIG. 14). The dimensions of the annular ring may be of any dimension capable of producing the needle of the present disclosure, such as a 3 mm to 5 mm inner diameter, 7 mm to 15 mm outer diameter, and 0.5 mm to 1.5 mm depth. The inner diameter, outer diameter, and depth may be of any dimension capable of providing the lamellae with surface tension to produce a needle of the present disclosure. The annular ring may be of any conductive material. The annular ring may include a metal washer.

A voltage of 1 V to 100 V may be applied to a closed circuit, wherein wires may connect the annular ring 405 and lamellae 420 to the crucible 410, electrifying the annular ring having a liquid lamella in the center, the metal wire 400, the salt solution 415, and/or the crucible 410. The etching may stop at the instant the needle forms to prevent dulling of the tip, wherein the lower portion of the wire 400 may fall off. While the following steps have been described, any etching technique capable of producing a needle having a tip with a radius of curvature of 1 nm to 1500 nm is possible and within the scope of the present disclosure.

The present disclosure provides a method of producing at least two needles of the present disclosure including at least two systems, wherein a system includes an annular ring having a liquid lamella, a metal wire, a salt solution, and/or a crucible according to the methods of FIG. 14. Each individual system may be connected to receive a voltage at the same time. Etching may be performed on the at least two systems according to the methods of the present disclosure, wherein the method may produce at least 2, 5, 10, 25, 50, 75, 100, 500, 1000, 10000, and at least 20,000 needles of the present disclosure at the same time.

The liquid lamella may include 3M to 5M of a metal hydroxide such as KOH, and the like. The salt solution may include a saturated sodium chloride solution, and the like.

The present disclosure provides methods for detecting at least one analyte. The method may include providing a sample. Once a sample is provided, an electrical potential or voltage may be provided to at least one needle of the present disclosure. The electrical potential may cause an ionization region at the tip of the at least one needle to convert at least one analyte of the sample to at least one gaseous analyte ion. The methods may collect the at least one gaseous analyte ion into an inlet or orifice of a mass spectrometer. The methods may further analyze the at least one gaseous analyte ion using the mass spectrometer, wherein analyzing may include a qualitative or quantitative analysis. The analysis may include a mass to charge ratio (m/z) analysis. The method may display a result to a user, wherein the result may include displaying a mass spectrum or result on a graphical user interface. The mass spectrum may include a graphical display of abundance (arbitrary units) or percent relative abundance vs. m/z.

Qualitative analysis, as used herein, refers to any method or analysis of determining the presence or absence of chemical components or analytes in a sample. Quantitative analysis, as used herein, refers to any method or analysis of determining the amount of various chemical components or analytes in a sample.

As used herein, an “analyte” may refer to any substance whose chemical constituents are being analyzed and/or measured. An analyte may include, but is not limited to, an inorganic compound, an organic compound, a volatile organic compound, a semi-volatile organic compound, and the like. As used herein, a “sample” is the object of interest, including, but not limited to, human tissue, animal tissue, exhaled breath, paper currency, and the like. As used here, a sample may include a sample in gas, liquid, and/or solid phases.

The method may be performed for at least one scan of a mass spectrometer, such as for one second. The method may be performed continuously for up to one month, such as up to 1 hour, 6 hours, 12 hours, 20 hours, 24 hours, one week, and three weeks, including, but not limited to, 1 second to 1 hour, one second to 24 hours, one second to one week, and one second to three weeks. A system may require maintenance over a period of time of continuous use. One scan of a mass spectrometer may be less than one second. While a timeframe of one second has been described, performing the method for less than one second is possible and within the scope of the present disclosure. The method may be limited by the speed and/or number of scans possible for the mass spectrometer used. The method may be performed at specified intervals, such as once every hour.

The ionization region may be created at or near atmospheric pressure. The ionization region may be created at a pressure of 1 ATM to 7 ATM. The pressure at the ionization region may be at least 1 ATM, such as, without limitation, 2, 3, 4, 5, 6, and at least 7 ATM. The pressure at the ionization region may be no more than 7 ATM, including, without limitation, 6, 5, 4, 3, 2, and no more than 1 ATM. Any combination of lower and upper limits may define the pressure at the ionization region, such as 1 ATM to 7 ATM, including, without limitation, 1 ATM to 2 ATM, 1 ATM to 3 ATM, 1 ATM to 4 ATM, 1 ATM to 5 ATM, 1 ATM to 6 ATM, 1 ATM to 7 ATM, 2 ATM to 3 ATM, 3 ATM to 4 ATM, 4 ATM to 5 ATM, 5 ATM to 6 ATM, and 6 ATM to 7 ATM. While a pressure of 1 ATM to 7 ATM has been described, any pressure at which an ionization region may be established is possible and within the scope of the present disclosure. Accordingly, the pressure may be less than 1 ATM.

The distance from the tip of the needle to the mass spectrometer inlet may be 0.1 mm to 15000 m. The distance may be at least 0.1 mm, such as, without limitation, 0.1 mm, 0.3 mm, 0.5 mm, 0.7 mm, 1.0 mm, 2.0 mm, 4.0 mm, 6.0 mm, 8.0 mm, 10.0 mm, 25 mm, 50 mm, 100 mm, 1000 mm, 5000 mm, 10000 mm, and 15000 mm. The distance may be no more than 15000 mm, including, without limitation, 10000 mm, 5000 mm, 1000 mm, 100 mm, 75 mm, 50 mm, 25 mm, 10.0 mm, 8.0 mm, 6.0 mm, 4.0 mm, 2.0 mm, 1.0 mm, 0.7 mm, 0.5 mm, 0.3 mm, and 0.1 mm. Any combination of lower and upper limits may define the distance, such as 0.1 mm to 15000 mm, including, without limitation, 0.1 mm to 0.3 mm, 0.3 mm to 0.5 mm, 0.5 mm to 0.7 mm, 0.7 mm to 1.0 mm, 1.0 mm to 3.0 mm, 3.0 mm to 5.0 mm, 5.0 mm to 7.0 mm, 7.0 mm to 10.0 mm, 10.0 mm to 25 mm, 25 mm to 50 mm, 50 mm to 75 mm, 75 mm to 100 mm, 100 mm to 1000 mm, 1000 mm to 5000 mm, 5000 mm to 10000 mm, and 10000 to 15000 mm.

The distance from the sample and tip of the needle may be 0.01 mm to 10000 mm. The distance may be at least 0.01 mm, such as, without limitation, 0.05, 0.1, 0.3, 0.5, 0.7, 1.0, 2.0, 3.0, 4.0, 5.0, 6.0, 7.0, 8.0, 9.0, and 10.0 mm15, 25, 50, 100, 250, 500, 1000, 2500, 5000, 7500, and at least 10000 mm. The distance may be no more than 10000 mm, including, without limitation, 7500, 5000, 2500, 1000, 500, 250, 100, 50, 25, 15, 10, 9.0, 8.0, 7.0, 6.0, 5.0, 4.0, 3.0, 2.0, 1.0, 0.7, 0.5, 0.3, 0.1, 0.05, and 0.01 mm. Any combination of lower and upper limits may define the distance, such as 0.01 mm to 10000 mm, including, without limitation, 0.01 mm to 0.05 mm, 0.05 mm to 0.1 mm, 0.1 mm to 0.3 mm, 0.3 mm to 0.5 mm, 0.5 mm to 0.7 mm, 0.7 mm to 1.0 mm, 1.0 mm to 3.0 mm, 3.0 mm to 5.0 mm, 5.0 mm to 7.0 mm, and 7.0 mm to 10.0 mm, 10 mm to 25 mm, 25 mm to 50 mm, 50 mm to 250 mm, 250 mm to 1000 mm, 1000 mm to 5000 mm, and 5000 mm to 10000 mm. While a distance from the sample and the tip of the needle from 0.01 mm to 10000 mm has been described, any other distance capable of analyzing at least one sample without causing destruction of the sample or any other distance capable of producing a useful signal intensity to analyze at least one sample according to the methods and systems of the present disclosure is possible and within the scope of the present disclosure. Accordingly, the distance from the sample and the tip of the needle may be up to 100 m.

The mass spectrometer may have an inlet capillary temperature. The inlet capillary temperature may be 150° C. to 300° C. The temperature may be at least 150° C., such as, without limitation, 175, 200, 225, 250, 275, and 300° C. The temperature may be no more than 300° C., including, without limitation, 275, 250, 225, 200, 175, and 150° C. Any combination of lower and upper limits may define the distance, such as 150° C. to 175° C., 175° C. to 200° C., 200° C. to 225° C., 225° C. to 250° C., 250° C. to 275° C., and 275° C. to 300° C. While an inlet capillary temperature of 150° C. to 300° C. has been described, any other temperature capable of analyzing at least one sample according to the methods and systems of the present disclosure is possible and within the scope of the present disclosure.

The electrical potential or voltage may be at least 0.1 kV, such as, without limitation 0.2 kV, 0.3 kV, 0.4 KV, 0.5 kV, 1.0 kV, 1.5 kV, 2.0 kV, 2.5 kV, 5 kV, 10 kV, 15 kV, and 20 kV. The electrical potential may be no more than 20 kV, such as, without limitation 15 kV, 10 kV, 5 kV, 2.5 kV, 2.0 kV, 1.5 kV, 1.0 kV, 0.5 kV, 0.4 KV, 0.3 kV, 0.2 kV, and no more than 0.1 kV. Any combination of lower and upper limits may define the electrical potential, such as 0.1 kV to 2.5 kV, including, without limitation, 0.1 kV to 0.5 kV, 0.5 kV to 1.0 kV, 1.0 kV to 1.5 kV, 1.5 kV to 2.0 kV, 2.0 kV to 2.5 kV, 2.5 kV to 5 kV, 5 kV to 10 kV, 10 kV to 15 kV, and 15 kV to 20 kV.

The present disclosure provides systems for detection of at least one analyte. The systems of the present disclosure may be in an open configuration or an enclosed configuration. FIG. 6 is an illustration of an open system according to the present disclosure, wherein the open system includes a needle 100 of the present disclosure. The needle may have any electrical potential or voltage (V) applied through a resistor (R). The systems of the present disclosure may include any device capable of applying a voltage of 1 kV to 20 kV according to the methods of the present disclosure. The needle 100 may be placed coaxial or perpendicular to a mass spectrometer inlet 120. The tip of the needle may be placed a distance from a sample 105 according to methods of the present disclosure. After applying an electrical potential to the needle 100, a corona discharge 110 may produce an ionization region at the tip to convert at least one analyte of the sample to at least one gaseous analyte ion. The mass spectrometer inlet 120 may be adapted to collect the at least one gaseous analyte ion into a mass spectrometer, wherein the mass spectrometer may be configured to qualitatively analyze the at least one gaseous analyte.

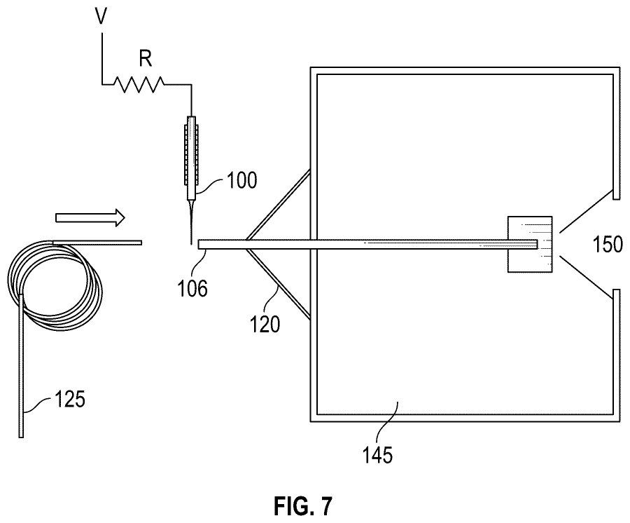

FIG. 7 illustrates an open system of the present disclosure, wherein a transfer line 125 may supply gaseous and/or liquid samples to be analyzed by the needle, methods, and systems of the present disclosure. The needle 100 of the present disclosure may be placed perpendicular to the mass spectrometer inlet 120. The transfer line 125 may be configured to disperse a gaseous and/or liquid sample coaxial to the tip of the needle. A voltage (V) may be applied through a resistor (R) to create an ionization region at the tip of the needle to convert at least one analyte of the sample to at least one gaseous analyte ion according to the methods of the present disclosure. The at least one gaseous analyte ion may be collected by an ion transfer tube 106 adapted to receive the mass spectrometer inlet 120 to be analyzed by the mass spectrometer 150 to qualitatively analyze the at least one gaseous analyte ion. The mass spectrometer inlet 120 may be configured as a part of a mass spectrometer interface 145. As used herein, a mass spectrometer interface 145 may include any device or system as a part of a mass spectrometer capable of transferring the at least one gaseous analyte ion to the mass spectrometer to be analyzed according to the methods and systems of the present disclosure. The interface may include an ion transfer tube 106 and the mass spectrometer inlet 120. The mass spectrometer interface 145 may have a vacuum.

While an open system of the present disclosure having one needle has been described, open systems having more than one needle are possible and within the scope of the present disclosure. For example, one needle may be placed perpendicular to the mass spectrometer inlet according to the methods of the present disclosure, and a second needle may be placed coaxial to the mass spectrometer inlet according to the methods of the present disclosure.

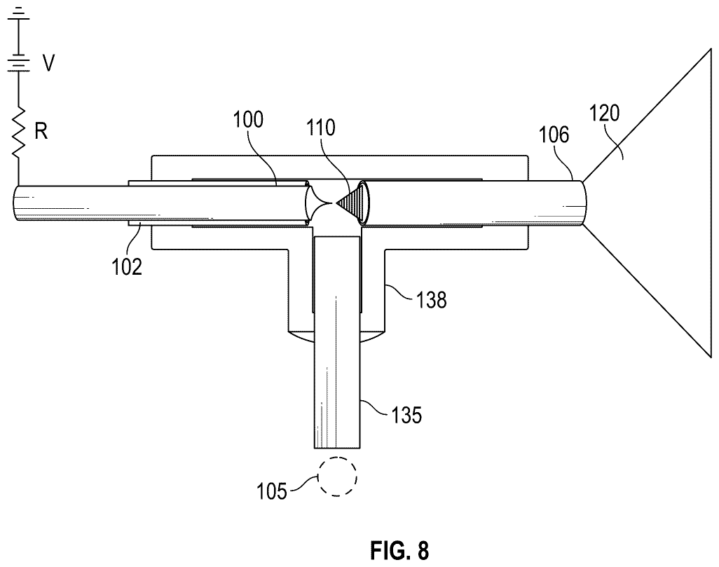

FIG. 8 is an illustration of an enclosed system according to the present disclosure. The enclosed system may include a needle 100 positioned coaxial or perpendicular to a mass spectrometer inlet 120, wherein the needle may be housed within an assembly 138 capable of holding the needle 100, an ion transfer tube 106 adapted to receive the mass spectrometer inlet 120 and at least one gaseous analyte ion, and a sample collection tube 135 in an enclosed configuration. The assembly 138 may include any device capable of maintaining the enclosed configuration, such as a PEEK tee assembly. The needle may be sheathed within tubing 102, wherein the tubing may include any material capable of securing the needle within the assembly 138, such as an ETFE tubing. The enclosed system may block ambient air flux, wherein the sample may be collected from the sample collection tube 135, and wherein the sample collection tube 135 may include any length allowing for direct analysis of a sample 105 isolated from background air. Enclosed configurations of the present disclosure may also protect needles of the present disclosure from accidental damage. An electrical potential or voltage (V) may be applied through a resistor (R) to create a corona discharge 110 or ionization region at the tip of the needle to convert at least one analyte of the sample to at least one gaseous analyte ion according to the methods of the present disclosure. The at least one gaseous analyte ion may be collected by the ion transfer tube 106 adapted to receive the mass spectrometer inlet 120 to be analyzed by a mass spectrometer to qualitatively analyze the at least one gaseous analyte ion.

In open and enclosed systems of the present disclosure, the distance from the mass spectrometer inlet to the tip of the needle may be 0.1 mm to 15000 mm according to the methods of the present disclosure.

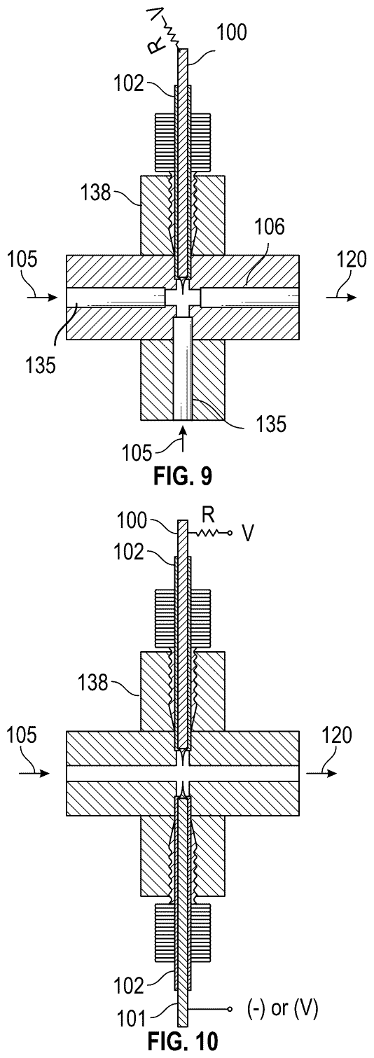

FIG. 9 is an illustration of an enclosed system according to the present disclosure, wherein the needle 100 is positioned perpendicular to the mass spectrometer inlet 120. The needle may be sheathed within tubing 102, wherein the tubing may include any material capable of securing the needle within the assembly 138 according to the methods and systems of the present disclosure. The enclosed system may include two sample collection tubes 135 placed both beneath the tip of the needle and perpendicular to the tip of the needle to collect at least one sample 105. An electrical potential or voltage (V) may be applied through a resistor (R) to create an ionization region at the tip of the needle to convert at least one analyte of the sample to at least one gaseous analyte ion according to the methods of the present disclosure. The at least one gaseous analyte ion may be collected by an ion transfer tube 106 adapted to receive the mass spectrometer inlet 120 to be analyzed by a mass spectrometer to qualitatively analyze the at least one gaseous analyte ion.

While an enclosed system of the present disclosure having one needle has been described, enclosed systems having more than one needle are possible and within the scope of the present disclosure.

FIG. 10 is an illustration of an enclosed system according to the present disclosure including two needles of the present disclosure. The first needle 100 of the present disclosure may be positioned perpendicular to the mass spectrometer inlet 120. The second needle 101 may be positioned perpendicular to the mass spectrometer inlet 120 and underneath the first needle 100. An electrical potential or voltage (V) may be applied through a resistor (R) to the first needle 100 to create an ionization region at the tip of the first needle 100 to convert at least one analyte of the sample to at least one gaseous analyte ion according to the methods of the present disclosure. The second needle 101 may be applied a voltage or connected to a ground according to the methods of the present disclosure. The second needle 101 may create a second ionization region at the tip of the second needle 101 to convert at least one analyte of the sample to at least one gaseous analyte ion to be analyzed according to the methods of the present disclosure. Both needles may be sheathed within tubing 102, wherein the tubing may include any material capable of securing the needle within the assembly 138 according to the methods and systems of the present disclosure. The sample 105 may be collected coaxial to the mass spectrometer inlet 120 according to the methods and systems of the present disclosure.

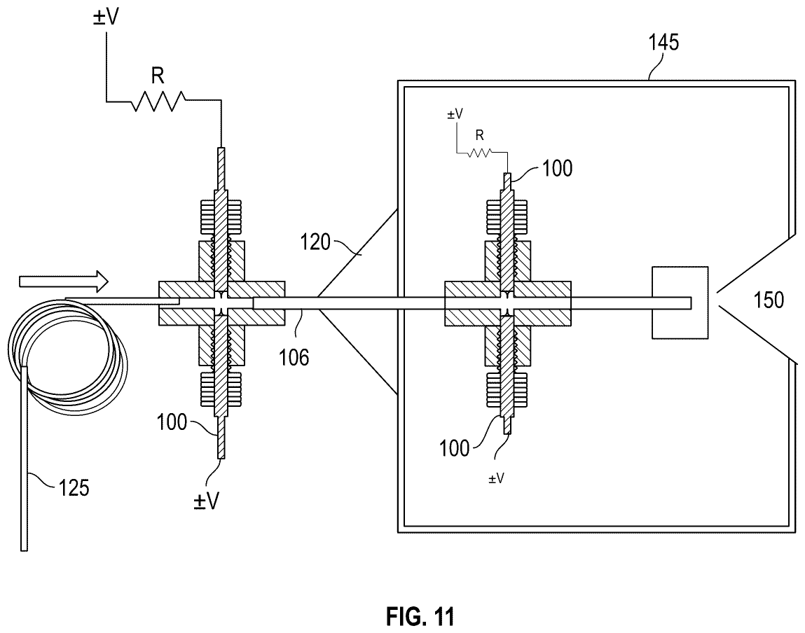

FIG. 11 is an illustration of a system of the present disclosure including a first system as described in FIG. 10 and a mass spectrometer interface 145 having a second system including two or more needles of the present disclosure in an enclosed configuration, wherein both needles may be positioned perpendicular to the mass spectrometer inlet. A transfer line 125 may be configured to disperse a gaseous and/or liquid sample coaxial to the tip of the needles of the first system, wherein a voltage may be applied to both needles of the first system according to the methods and systems of the present disclosure, wherein each needle creates an ionization region at the tip of each respective needle to convert at least one gaseous analyte of the sample to at least one gaseous analyte ion. The at least one gaseous analyte ion may be collected by an ion transfer tube 106 adapted to receive a mass spectrometer inlet 120. The at least one gaseous analyte ion may be received by the second system, wherein the needles of the second system may create an ionization region at the tip of the needles to further ionize remaining neutral gaseous analytes, wherein the resulting gaseous analyte ion may be analyzed by the mass spectrometer 150. The present disclosure also provides for a system having at least one needle of the present disclosure in an enclosed configuration within a mass spectrometer interface, wherein the second system of FIG. 11 is the only system.

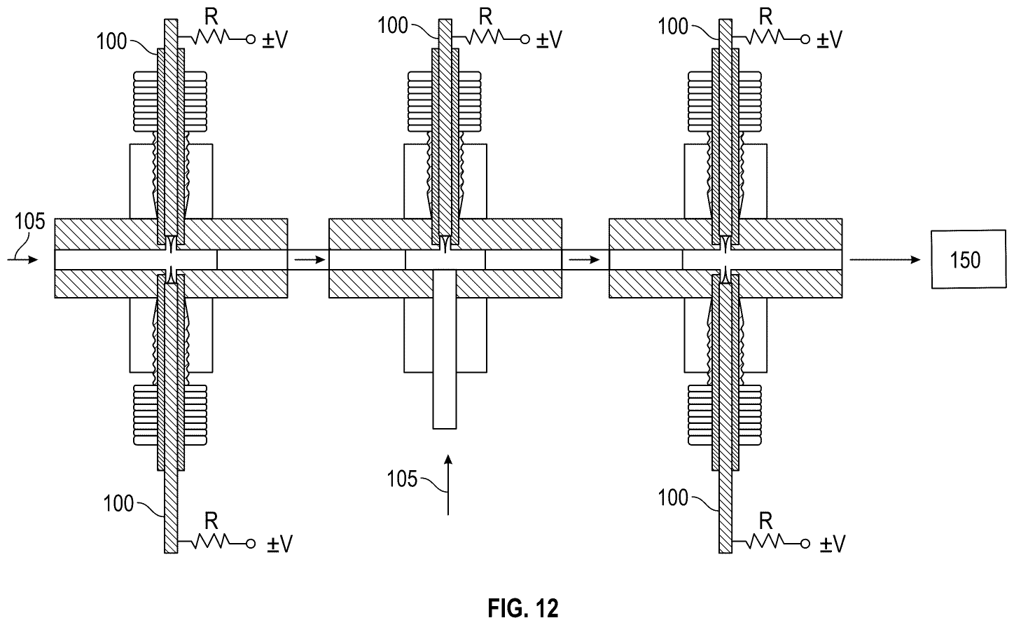

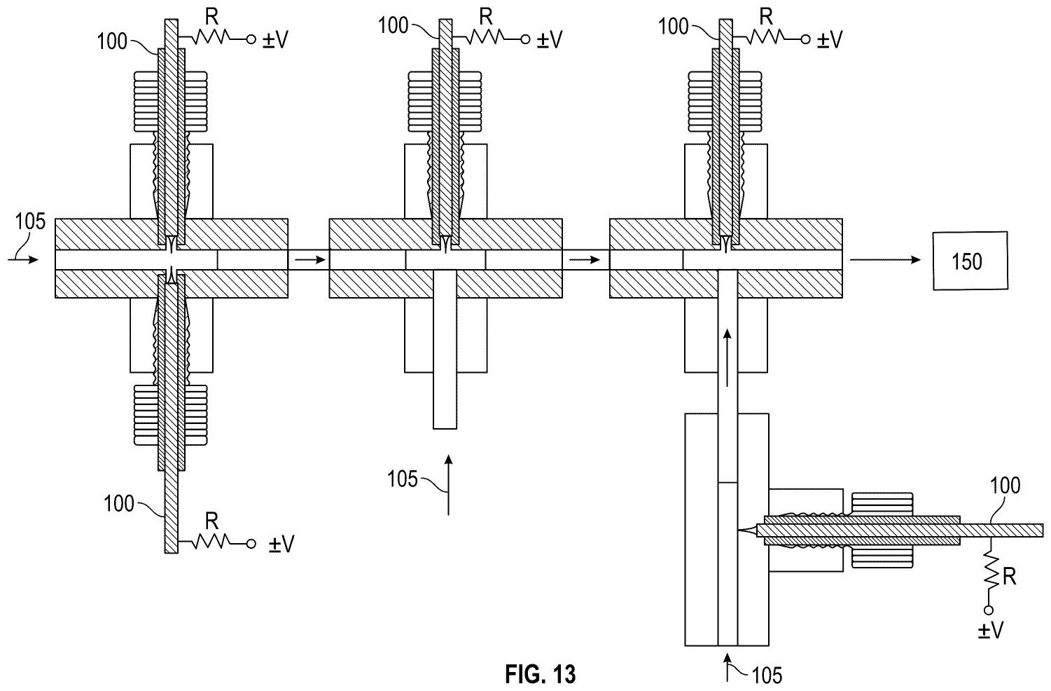

While an enclosed system of the present disclosure having one needle has been described, enclosed systems having more than one needle and more than one assembly for at least two serial or parallel ionization discharges are possible (FIG. 12 & FIG. 13) and within the scope of the present disclosure. The needles may be applied a voltage to create an ionization region at the tip of each needle, wherein at least one analyte is converted to at least one gaseous analyte ion, wherein the at least one gaseous analyte ion may be analyzed by a mass spectrometer after serial or parallel ionization discharges according to the methods and systems of the present disclosure. At least two serial and/or parallel ionization discharges may further ionize remaining neutral gaseous analytes. According to certain aspects, ion beams may be combined to increase the overall signal or to cause an ion-molecule reaction or an ion-ion reaction.

Open or enclosed systems may include one or more needles having an aspect ratio of 2:1 to 1:50 as described in the present disclosure. For an enclosed system, a shorter tip may reduce needle vibration and allow for the tips to be contained in tubes and/or assemblies.

The sample collection tube of the present disclosure may include any length allowing for direct analysis of a sample according to the methods and systems of the present disclosure, including, but not limited to, 1 mm to 15 m. The ion transfer tube of the present disclosure may include any length capable of transferring at least one gaseous analyte ion from the ionization region to the mass spectrometer inlet, including, but not limited to, 1 mm to 15 m. The dimensions of the assembly of the present disclosure may include any dimensions capable of holding at least one needle of the present disclosure and analyzing at least one analyte of a sample according to the methods and systems of the present disclosure, including, but not limited to, a length of 250 microns to 2000 mm.

An open system of the present disclosure may include a conduit to transport the sample to the ionization region, wherein the conduit may include a tube or a transfer line. The transfer line may be heated or unheated. The conduit may allow at least one ion formed at the tip of the needle to be mass analyzed by a mass spectrometer.

The open and enclosed systems of the present disclosure may include a counter-electrode when more than one needle of the present disclosure is used.

The assembly or assemblies of the present disclosure may include a high-pressure liquid chromatography (HPLC) “tee” wherein the needle may be placed inside. While an HPLC “tee” has been described, any other enclosure that allows for a corona discharge is possible and within the present disclosure.

The open and/or enclosed systems of the present disclosure may be compatible with any mass spectrometer.

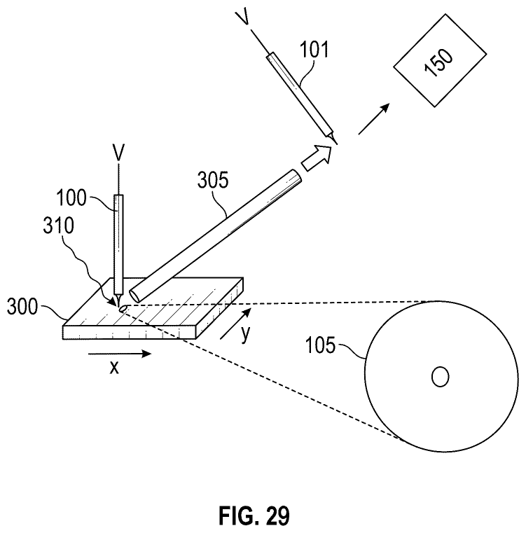

The present disclosure provides for a surface analysis and imaging system (FIG. 29). The surface analysis and imaging system may include a first needle 100 of the present disclosure having a voltage (V) applied according to the methods of the present disclosure. The system may include a stage 300, wherein the stage may be motorized or fixed in place. A sample 105, such as a single cell, a drop of liquid, tissue, and the like may be placed on the stage 300 for analysis. The system may include a laser capable of generating a laser beam 310. A heated transfer tube 305 may collect the gaseous analyte ions generated by the ionization region at the tip of the first needle 100 after a voltage is applied according to the methods of the present disclosure. The heated transfer tube 305 may transfer the gaseous analyte ions to a second needle 101 of the present disclosure, wherein a voltage may be applied to the second needle to generate a second ionization region at the tip of the second needle 101, wherein remaining neutral gaseous analytes may be ionized, and wherein the gaseous analyte ions may then be transferred to a mass spectrometer 150 to be analyzed according to the methods and systems of the present disclosure.

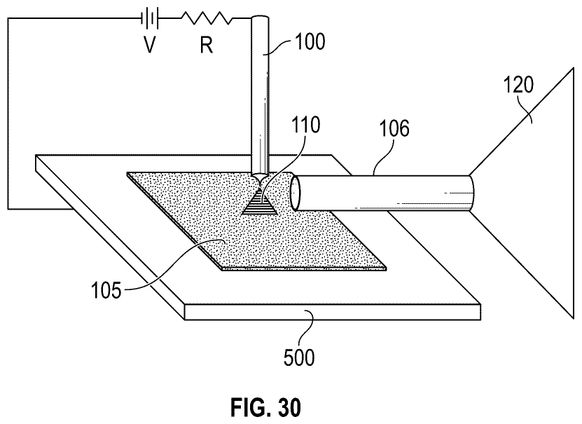

The present disclosure provides for a surface analysis and imaging system (FIG. 30) including one needle 100 of the present disclosure. A sample 105 may be placed on a conductive plate 500, wherein the conductive plate 500 may include a stage, wherein the stage may be motorized or fixed in place. A voltage (V) may be applied to the needle 100 according to the methods of the present disclosure, wherein an ionization region 110 at the tip of the needle 100 may be created to generate at least one gaseous analyte ion. An ion transfer tube 106 may transfer the gaseous analyte ions of the sample to a mass spectrometer inlet 120, wherein the gaseous analyte ions may be analyzed by a mass spectrometer according to the methods and systems of the present disclosure.

The present disclosure provides a system to determine in real-time whether a tissue is cancerous or healthy. The system may aid a surgeon in determining whether the surgeon should proceed or stop the excision of additional tissue. Conventional methods of excising a cancerous or potentially cancerous tumor or mass are difficult to determine whether a sufficient amount of cancerous tissue has been removed. A surgeon may excise more healthy tissue than necessary or not all of the cancerous tissue. When testing of the tissue is required during surgery to help determine cancerous margins, the testing is time intensive.

The system may include at least one needle of the present disclosure, wherein a voltage may be applied to create an ionization region at the tip of the needle to generate gaseous analyte ions, wherein the gaseous analyte ions may be analyzed according to the methods and systems of the present disclosure.

The present disclosure further provides a devices, systems, and methods for disease detection, cancer detection, disease biomarkers, biomarker volatilome analysis, and/or fence post monitoring of organic compounds according to the needle, methods, and systems of the present disclosure. A disease may be any illness or sickness detectable by the devices, methods, and systems of the present disclosure, including, but not limited to, any disease having a specific biomarker or volatilome. A biomarker, as used here, may refer to any qualitatively and/or quantitatively measurable substance in an organism whose presence is indicative of some phenomenon such as a disease, infection, or environmental exposure. As used herein, a volatilome may include all volatile metabolites, volatile organic compounds, and volatile inorganic compounds of an organism.

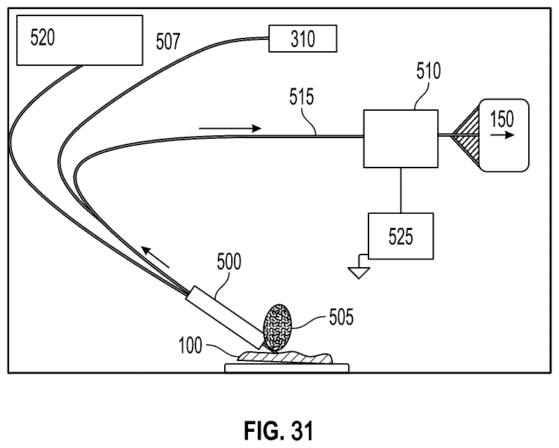

The present disclosure further provides a device and system for detection of volatile and semi-volatile analytes from samples such as skin, hair, other organic tissues, and the like. The system (FIG. 31) may include a surgical instrument 500, such as a radiofrequency surgical instrument or scalpel having a radio-frequency supply 520 and the like. The surgical instrument may be used on a sample 105, wherein a droplet plume 505 may be formed after laser ablation of the sample 105 by a laser 310 connected to the surgical device 500 by wiring 507 such as fiber optics The surgical instrument 500 may be connected to a closed system 510 according to the present disclosure, wherein tubing 515, such as Teflon tubing, may be used to pull the vapors and ions of the droplet plume 505 into the closed system 510, wherein the closed system may include at least one needle of the present disclosure. The closed system may perform an analysis of the vapors and ions according to the methods and systems of the present disclosure, wherein a voltage may be applied to the at least one needle to create an ionization region at the tip of the needle, wherein the ionization region generates at least one gaseous analyte ion to be analyzed by a mass spectrometer 150. The closed system may further include an ionizer control 525 to control the electrical potential applied to the system of the present disclosure.

The systems of the present disclosure may include a device, such as an ionizer control, to control the electrical potential applied to a system, wherein the ionizer control may include a power supply and/or any device capable of controlling the voltage applied to the needle(s) of the present disclosure.

The present disclosure may provide methods and systems of mass spectrometry tissue imaging. Conventional methods of mass spectrometry tissue imaging require matrix assisted laser desorption ionization (MALDI) and use time-of-flight (TOF) mass spectrometry. However, the methods and systems of the present disclosure may be performed at or near atmospheric pressure as described herein. The sample may be proved by rastering across the sample with and/or without a carbon dioxide laser beam, and the sample may be analyzed to determine a mass spectrum according to the methods and systems of the present disclosure. Linear motors may allow for rastering a tissue stage as shown in FIGS. 29 & 30. A high-resolution image may be generated by plotting specific ion intensities from the data collected from the mass spectrum analysis of the present disclosure. Unlike the prior art, the method does not require a matrix for ionization and may be performed at or near atmospheric pressure.

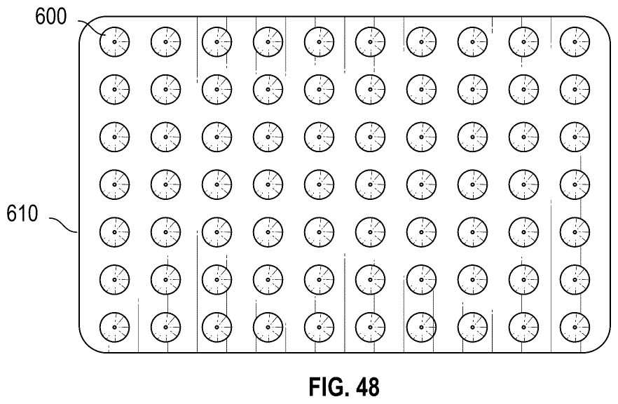

The present disclosure also provides a system including a plate 610 having more than one needle 600 of the present disclosure, wherein the needles consist of only a tip of the present disclosure (FIG. 48). The needles may be attached to the plate and configured to receive an electrical potential or voltage. The plate may include an array of needles arranged in a pattern, including, a linear pattern, a grid pattern, a circular pattern, and the like. The system may include more than one needle, including, but not limited to, at least 2, 5, 10, 15, 20, 25, 50, 100, 150, 200, 500, 1000, and at least 10,000 needles consisting of only a tip of the present disclosure. All needles may be applied a voltage at the same time The system may allow the analysis of a large sample, wherein the entire sample may be analyzed. The metal plate may include any metal capable of conducting electricity, such as aluminum, silver, copper, gold, conductive polymeric material, and the like.

The present disclosure also provides a system including a plate having more than one needle of the present disclosure, wherein the needles consist of only a tip of the present disclosure. The needles may be attached to the plate and connected to a power supply via wiring. The system may include at least one switch or device capable of selectively applying a voltage to a subsection of needles of the system. The system may include more than one needle, including, but not limited to, at least 2, 5, 10, 15, 20, 25, 50, 100, 150, 200, 500, 1000, and at least 10,000 needles consisting of only a tip of the present disclosure. Selected needles may be applied a voltage, wherein a user may selectively choose which needles to apply a voltage. The system may allow the analysis of a large sample, wherein specified sections of the sample may be analyzed. The plate may include an insulator or any material capable of supporting and attaching the needles of the system, including, but not limited to, stainless steel, a polymeric material, and the like.

According to the needles, methods, and systems of the present disclosure, an ionization region may be created at the tip of at least one needle, wherein ions, electrons, cations, and/or anions of a sample may be collected in an inlet of a mass spectrometer using an ion transfer tube or any other aperture capable of pulling the ionized ions, electrons, cations, and/or anions into a mass spectrometer interface. The primary source of ions may be by atmospheric pressure chemical ionization. The needles, methods, and systems of the present disclosure may be used as a replacement for an atmospheric pressure chemical ionization (ACPI) ion source in mass spectrometry.

The needles, methods, and systems of the present disclosure may provide real-time analysis of at least one analyte.

The needle of the present disclosure may be applied a voltage through a resistor, wherein the resistor may have a resistance of 1 MΩ to 800 MΩ. As used herein, a “resistor” may refer to any passive electrical component that creates resistance in the flow of an electric current. A resistor of the present disclosure may have a resistance of at least 1 MΩ, such as, without limitation 5, 10, 25, 50, 100, 150, 200, 250, 300, 350, 400, 450, 500, 600, 700, and 800 MΩ. The resistance may be no more than 800 MΩ, such as, without limitation 700, 600, 500, 450, 400, 350, 300, 250, 200, 150, 100, 50, 25, 10, 5, and 1 MΩ. Any combination of lower and upper limits may define the resistance, such as 1 MΩ to 800 MΩ, including, without limitation, 1 MΩ to 5 MΩ, 5 MΩ to 10 MΩ, 10 MΩ to 25 MΩ, 25 MΩ to 50 MΩ, 50 MΩ to 100 MΩ, 100 MΩ to 150 MΩ, 150 MΩ to 200 MΩ, 200 MΩ to 250 MΩ, 250 MΩ to 300 MΩ, 300 MΩ to 350 MΩ, 350 MΩ to 400 MΩ, 400 MΩ to 450 MΩ, 450 MΩ to 500 MΩ, 500 MΩ to 600 MΩ, 600 MΩ to 700 MΩ, and 700 MΩ to 800 MΩ.

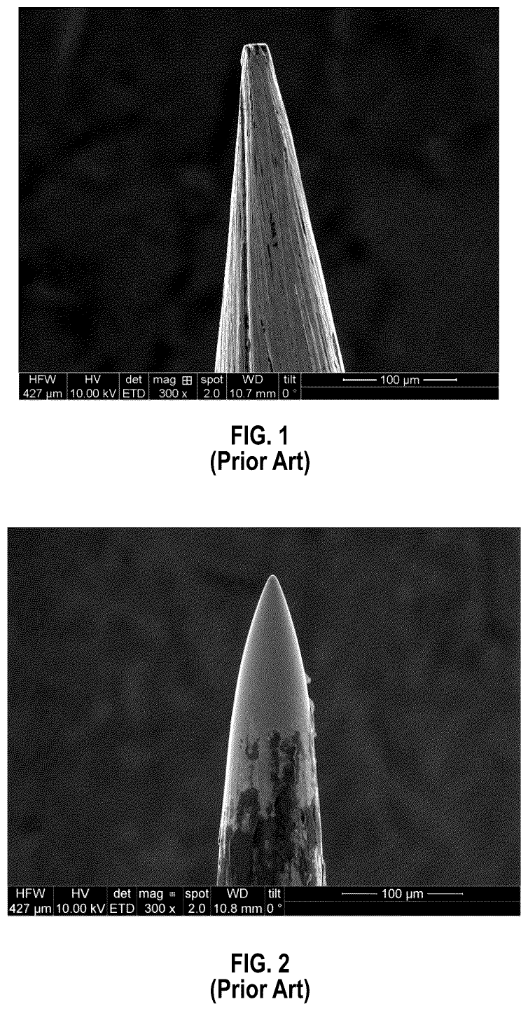

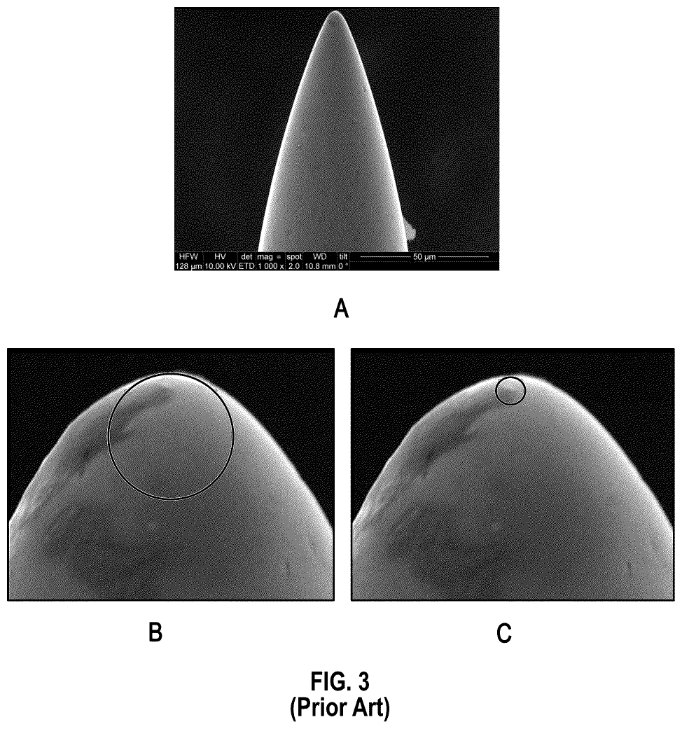

Conventional needles known in the art (FIG. 1 & FIG. 2) have a radius of curvature of at least 1500 nm. Habib et. al, 2013 reports the radius of curvature of the prior art needle of FIG. 2 as 350 nm. Conventional methods of measuring a radius of curvature tend to use a smaller magnification of a scanning electron microscopy image compared to the present disclosure or conventional methods may use optical microscope imaging, leading to an incorrect measurement of the radius of curvature. An image with a higher magnification may result in a more accurate measurement of the present disclosure. As such, a radius of curvature reported in the prior art tends to be reported incorrectly, and the actual radius of curvature tends to be larger than the reported ROC (FIG. 3A-C).

The present disclosure provides a method of determining a radius of curvature. The method may obtain an image of the needle using a scanning electron microscope. The image may be obtained using the scanning electron microscope at a magnification including, but not limited to, 300×, 1000×, 240 k×, and the like. The magnification may include the highest magnification at which the entire tip of the needle is visible. The scanning electron microscope images may be useful for examining the morphology of the needle tip. The image with the highest magnification, such as 1000×to 240 k×, may be used to calculate the radius of curvature. A circle may be drawn to follow the curvature of the needle tip's apex. The circle may be drawn by hand or using any image processing software known in the art, such as ImageJ (National Institutes of Health). The method may calculate an area of the circle using the scale bar of the scanning electron microscopy image and conventional methods known in the art. The method may calculate the radius of curvature from the area by determining the value of r in A=πr² (EQ. 1). The methods of the present disclosure provide a more accurate measurement of the radius of curvature compared to conventional methods known in the art, such as (Habib et. al, 2013).

### Definitions

Unless otherwise defined, all terms (including technical and scientific terms) used herein have the same meaning as commonly understood by one of ordinary skill in the art to which this disclosure belongs. As such, terms, such as those defined by commonly used dictionaries, should be interpreted as having a meaning that is consistent with their meaning in a context of a relevant art and should not be interpreted in an idealized or overly formal sense unless expressly so defined herein.

As used herein, the term “and/or” includes any and all combinations of one or more of the associated listed items. Likewise, as used in the following detailed description, the term “or” is intended to mean an inclusive “or” rather than an exclusive “or.” That is, unless specified otherwise, or clear from context, “X employs A or B” is intended to mean nay of the natural inclusive permutations. Thus, if X employs A; X employs B; or X employs both A and B, then “X employs A or B” is satisfied under any of the foregoing instances.

In the drawings, sizes, thicknesses, ratios, and dimensions of the elements may not be drawn to scale for ease of description and for clarity. Like numbers refer to like elements throughout.

The terminology used herein is for the purpose of describing particular examples only and is not intended to be limiting. As used herein, the singular forms “a”, “an”, and “the” may be intended to include the plural forms as well, unless the context clearly dictates otherwise. As example, “a” needle may include one or more needles, and the like.

The terms “comprises”, “comprising”, “including”, “having”, and “characterized by”, may be inclusive and therefore specify the presence of stated features, elements, compositions, steps, integers, operations, and/or components, but do not preclude the presence or addition of one or more other features, integers, steps, operations, elements, components, and/or groups thereof. Although these open-ended terms may be to be understood as a non-restrictive term used to describe and claim various aspects set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, described herein also specifically includes embodiments consisting of, or consisting essentially of, such recited compositions, materials, components, elements, features, integers, operations, and/or process steps. In the case of “consisting of”, the alternative embodiment excludes any additional compositions, materials, components, elements, features, integers, operations, and/or process steps, while in the case of “consisting essentially of”, any additional compositions, materials, components, elements, features, integers, operations, and/or process steps that materially affect the basic and novel characteristics may be excluded from such an embodiment, but any compositions, materials, components, elements, features, integers, operations, and/or process steps that do not materially affect the basic and novel characteristics may be included in the embodiment.

Any method steps, processes, and operations described herein may not be construed as necessarily requiring their performance in the particular order discussed or illustrated, unless specifically identified as an order of performance. It is also understood that additional or alternative steps may be employed, unless otherwise indicated.

In addition, features described with respect to certain example embodiments may be combined in or with various other example embodiments in any permutational or combinatory manner. Different aspects or elements of example embodiments, as disclosed herein, may be combined in a similar manner. The term “combination”, “combinatory,” or “combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included may be combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

The present disclosure may be described herein with reference to flowchart illustrations and/or block diagrams of methods, apparatus (systems), and computer program products according to the disclosure. It will be understood that each block of the flowchart illustrations and/or block diagrams, and combinations of blocks in the flowchart illustrations and/or block diagrams, may be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various aspects of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

Words such as “then,” “next,” etc. are not intended to limit the order of the steps; these words may be simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

In the description, certain details are set forth in order to provide a better understanding of various embodiments of the systems and methods disclosed herein. However, one skilled in the art will understand that these embodiments may be practiced without these details and/or in the absence of any details not described herein. In other instances, well-known structures, methods, and/or techniques associated with methods of practicing the various embodiments may not be shown or described in detail to avoid unnecessarily obscuring descriptions of other details of the various embodiments.

While specific aspects of the disclosure have been provided hereinabove, the disclosure may, however, be embodied in many different forms and should not be construed as necessarily being limited to only the embodiments disclosed herein. Rather, these embodiments may be provided so that this disclosure is thorough and complete, and fully conveys various concepts of this disclosure to skilled artisans.

All numerical quantities stated herein may be approximate, unless stated otherwise. Accordingly, the term “about” may be inferred when not expressly stated. The numerical quantities disclosed herein may be to be understood as not being strictly limited to the exact numerical values recited. Instead, unless stated otherwise, each numerical value stated herein is intended to mean both the recited value and a functionally equivalent range surrounding that value. At the very least, and not as an attempt to limit the application of the doctrine of equivalents to the scope of the claims, each numerical value should at least be construed in light of the number of reported significant digits and by applying ordinary rounding processes. Typical exemplary degrees of error may be within 20%, 10%, or 5% of a given value or range of values. Alternatively, the term “about” refers to values within an order of magnitude, potentially within 5-fold or 2-fold of a given value. Notwithstanding the approximations of numerical quantities stated herein, the numerical quantities described in specific examples of actual measured values may be reported as precisely as possible. Any numerical values, however, inherently contain certain errors necessarily resulting from the standard deviation found in their respective testing measurements.

All numerical ranges stated herein include all sub-ranges subsumed therein. For example, a range of “1 to 10” or “1-10” is intended to include all sub-ranges between and including the recited minimum value of 1 and the recited maximum value of 10 because the disclosed numerical ranges may be continuous and include every value between the minimum and maximum values. Any maximum numerical limitation recited herein is intended to include all lower numerical limitations. Any minimum numerical limitation recited herein is intended to include all higher numerical limitations.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, may be at least partially performed via at least one entity or actor in any manner.

While particular embodiments have been illustrated and described, it would be obvious to those skilled in the art that various other changes and modifications may be made without departing from the spirit and scope of the invention. Those skilled in the art will recognize or be able to ascertain using no more than routine experimentation, numerous equivalents to the specific apparatuses and methods described herein, including alternatives, variants, additions, deletions, modifications, and substitutions. This application including the appended claims is therefore intended to cover all such changes and modifications that may be within the scope of this application.

### Aspects

Aspect 1: A needle for mass spectrometry, comprising: a solid shaft; and a first end with a tip having a radius of curvature of less than 1500 nm, wherein the tip is distal from a second end of the needle, wherein the second end is configured to accept an electrical potential, and wherein the tip provides an ionization region when the electrical potential is applied.

Aspect 2: The needle of aspect 1, wherein the tip is tapered.

Aspect 3: The needle according to any of the foregoing aspects, wherein the length of the tip is less than 2.5 cm.

Aspect 4: The needle according to any of the foregoing aspects, wherein the length of the tip is 0.001 cm to 2.5 cm.

Aspect 5: The needle according to any of the foregoing aspects, wherein a cone height of the tip of the needle is less than 10,000 microns.

Aspect 6: The needle according to any of the foregoing aspects, wherein a cone height of the tip of the needle is less than 1000 microns.

Aspect 7: The needle according to any of the foregoing aspects, wherein a cone height of the tip of the needle is less than 750 microns.

Aspect 8: The needle according to any of the foregoing aspects, wherein a cone height of the tip of the needle is less than 500 microns

Aspect 9: The needle according to any of the foregoing aspects, wherein the radius of curvature is 1 to 1500 nm.

Aspect 10: The needle according to any of the foregoing aspects, wherein the radius of curvature is 1 to 800 nm.

Aspect 11: The needle according to any of the foregoing aspects, wherein the radius of curvature is 1 to 350 nm.

Aspect 12: The needle according to any of the foregoing aspects, wherein the radius of curvature is 1 to 250 nm.

Aspect 13: The needle according to any of the foregoing aspects, wherein the radius of curvature is 1 to 150 nm.

Aspect 14: The needle according to any of the foregoing aspects, wherein the radius of curvature is 1 to 100 nm.

Aspect 15: The needle according to any of the foregoing aspects, wherein the radius of curvature is 1 to 20 nm.

Aspect 16: The needle according to any of the foregoing aspects, wherein the radius of curvature is less than 1 nm.

Aspect 17: The needle according to any of the foregoing aspects, wherein a cone angle of the tip is 1 degree to 90 degrees.

Aspect 18: The needle according to any of the foregoing aspects, wherein a cone base is 0.1 mm to 3 mm.

Aspect 19: The needle according to any of the foregoing aspects, wherein the shaft has a length up to 10 m.

Aspect 20: The needle according to any of the foregoing aspects, wherein the tip of the needle is formed as a cone having concave sides.

Aspect 21: The needle according to any of the foregoing aspects, wherein the tip of the needle is formed as a cone having linear sides.

Aspect 22: The needle according to any of the foregoing aspects, wherein the tip of the needle has a parabolic, hyperbolic, or exponential shape.

Aspect 23: The needle according to any of the foregoing aspects, wherein the ionization region is created at or near atmospheric pressure.

Aspect 24: The needle according to any of the foregoing aspects, wherein the electric charge is 2.5 kV or less.

Aspect 25: The needle according to any of the foregoing aspects, wherein the electric charge is 1.5 kV or less.

Aspect 26: The needle according to any of the foregoing aspects, wherein the solid shaft has a diameter of 0.10 mm to 3.0 mm.

Aspect 27: The needle according to any of the foregoing aspects, wherein the tip comprises at least two whiskers.

Aspect 28: The needle according to any of the foregoing aspects, wherein performance of the needle is minimally reduced after at least two uses.

Aspect 29: The needle according to any of the foregoing aspects, wherein the needle has an aspect ratio of 2:1 to 1:50, wherein the aspect ratio comprises a ratio of a shaft diameter to a tip height.

Aspect 30: The needle according to any of the foregoing aspects, wherein the needle has an aspect ratio of 1:1, wherein the aspect ratio comprises a ratio of a shaft diameter to a tip height.

Aspect 31: The needle according to any of the foregoing aspects, wherein the needle is comprised of a material selected from tungsten, gold, platinum, titanium, and stainless steel.

Aspect 32: The needle according to any of the foregoing aspects, wherein the needle is comprised of a conductive non-metal material.

Aspect 33: The needle according to any of the foregoing aspects, wherein the needle is comprised of a ceramic material coated with a metal.

Aspect 34: The needle according to any of the foregoing aspects, wherein the needle is comprised of a conductive polymeric material.

Aspect 35: The needle according to any of the foregoing aspects, wherein the radius of curvature is determined by drawing a circle to follow the curvature of an apex of the tip using a scanning electron micrograph image of at least 300× magnification, calculating an area of the circle, and calculating the radius of curvature from the area.

Aspect 36: A needle for mass spectrometry, the needle consisting of a tip having a radius of curvature of 1 nm to 1500 nm.

Aspect 37: A method of manufacturing a needle having a tip with a radius of curvature of 1 nm to 1500 nm, the method comprising: inserting an end of a metal wire through a center of a conductive annular ring and into a crucible containing a salt solution; and applying a voltage, wherein the center of the conductive annular ring comprises a liquid lamella.

Aspect 38: The method of aspect 37, wherein the liquid lamellae comprises 3M to 5M of a metal hydroxide.

Aspect 39: The method according to any of the foregoing aspects, wherein the salt solution is a saturated sodium chloride solution.

Aspect 40: The method according to any of the foregoing aspects, wherein the conductive annular ring is a metal washer.

Aspect 41: A method for detecting at least one analyte, the method comprising the steps of: providing a sample; providing an electrical potential to any of the needles according to aspects 1 to 35, wherein the voltage causes an ionization region at the tip to convert the at least one analyte of the sample to at least one gaseous analyte ion; collecting the at least one gaseous analyte ion into an inlet of a mass spectrometer; and analyzing the at least one gaseous analyte ion using a mass spectrometer, wherein analyzing comprises a qualitative or quantitative analysis.

Aspect 42: The method according to any of the foregoing aspects, wherein qualitative analysis comprises determining a presence or an absence of at least one chemical component or at least one analyte in the sample.

Aspect 43: The method according to any of the foregoing aspects, wherein quantitative analysis comprises determining an amount of at least one chemical component or at least one analyte in the sample.

Aspect 44: The method according to any of the foregoing aspects, wherein analyzing the at least one gaseous analyte ion using a mass spectrometer comprises a mass to charge ration (m/z) analysis.

Aspect 45: The method according to any of the foregoing aspects, wherein the sample is a drug.

Aspect 46: The method according to any of the foregoing aspects, wherein the analyte is an inorganic compound.

Aspect 47: The method according to any of the foregoing aspects, wherein the analyte is an organic compound.

Aspect 48: The method according to any of the foregoing aspects, wherein the sample is human tissue.

Aspect 49: The method according to any of the foregoing aspects, wherein the sample is exhaled breath.

Aspect 50: The method according to any of the foregoing aspects, wherein the analyte is a volatile or semi-volatile organic compound.

Aspect 51: The method according to any of the foregoing aspects, wherein the method is continuously performed for at least one hour.

Aspect 52: The method according to any of the foregoing aspects, wherein the method is continuously performed for at least 20 hours.

Aspect 53: The method according to any of the foregoing aspects, wherein the method is performed for less than one second.

Aspect 54: The method according to any of the foregoing aspects, wherein the method is continuously performed for 1 second to 1 hour.

Aspect 55: The method according to any of the foregoing aspects, wherein the tip of the needle is less than 1 mm from the inlet

Aspect 56: The method according to any of the foregoing aspects, wherein the tip of the needle is 0.1 mm to 15000 mm from the inlet.

Aspect 57: The method according to any of the foregoing aspects, wherein the tip of the needle is 0.01 mm to 10000 mm from the sample.

Aspect 58: The method according to any of the foregoing aspects, wherein the voltage is less than 1 kV.

Aspect 59: The method according to any of the foregoing aspects, wherein the voltage is less than 10kV.

Aspect 60: The method according to any of the foregoing aspects, wherein the voltage is 1 kV to 20kV.

Aspect 61: The method according to any of the foregoing aspects, wherein the ionization region has a pressure of 1 ATM to 7 ATM.

Aspect 62: The method according to any of the foregoing aspects, wherein the ionization region has a pressure of less than 1 ATM.

Aspect 63: The method according to any of the foregoing aspects, wherein the ionization region has a pressure of at least 7 ATM.

Aspect 64: The method according to any of the foregoing aspects, wherein heat is applied to the surface of a sample to provide improved spatial resolution for imaging.

Aspect 65: A device having a needle with a tip having a radius of curvature of less than 1500 nm.

Aspect 66: An open system for detection of at least one analyte of a sample, the system comprising: a device adapted to apply a voltage of 1kV to 10kV to a needle with a tip having a radius of curvature of less than 1500 nm, wherein the voltage causes an ionization region at the tip to convert the at least one analyte to at least one gaseous analyte ion; a mass spectrometer inlet spaced 0.01 mm to 15000 mm from the tip of the needle, wherein the inlet is adapted to collect the at least one gaseous analyte; and a mass spectrometer configured to qualitatively analyze the at least one gaseous analyte ion.

Aspect 67: An enclosed system for detection of at least one analyte, the system comprising: a device adapted to apply a voltage of 1 kV to 10kV to an encased needle with a tip having a radius of curvature of less than 350 nm, wherein the voltage causes an ionization region at the tip to convert the at least one analyte to at least one gaseous analyte ion; a mass spectrometer inlet spaced 0.01 mm to 15000 mm from the tip of the needle, wherein the inlet is adapted to collect the at least one gaseous analyte; and a mass spectrometer configured to qualitatively analyze the at least one gaseous analyte.

Aspect 68: The system according to any of the foregoing aspects, wherein a counter electrode is provided.

Aspect 69: The system according to any of the foregoing aspects, wherein a resistor is provided.

Aspect 70: The system according to any of the foregoing aspects, further comprising a conduit to transport the sample to the ionization region.

Aspect 71: The system according to any of the foregoing aspects, further comprising at least two needles with a tip having a radius of curvature of less than 1500 nm in a serial configuration.

Aspect 72: The system according to any of the foregoing aspects, further comprising at least two needles with a tip having a radius of curvature of less than 1500 nm in a parallel configuration.

Aspect 73: The system according to any of the foregoing aspects, further comprising at least two needles with a tip having a radius of curvature of less than 1500 nm in a serial and a parallel configuration.

Aspect 74: The system according to any of the foregoing aspects, wherein the conduit is a heated transfer line.

Aspect 75: The system according to any of the foregoing aspects, wherein the conduit allows at least one ion formed at the tip of the needle to be mass analyzed by the mass spectrometer, wherein the sample is placed less than 100 mm from the tip of the needle.

Aspect 76: The system according to any of the foregoing aspects, wherein at least two needles having a radius of curvature less than 1500 nm are used.

Aspect 77: A method for mass spectrometer imaging of an inorganic surface or an organic surface, comprising: providing an inorganic or organic sample; providing an electrical potential to a first needle according to claims 1 to 35, wherein the voltage causes an ionization region at the tip to convert at least one analyte of the inorganic or organic sample to at least one gaseous analyte ion; collecting the at least one gaseous analyte ion via a transfer tube, wherein the transfer tube may be connected to a second needle according to claims 1 to 35, wherein a second electrical potential may be applied to the second needle, wherein the voltage causes an ionization region at the tip to convert at least one analyte to at least one gaseous analyte ion; and analyzing the at least one gaseous analyte ion using a mass spectrometer, wherein analyzing comprises a qualitative or quantitative analysis.

Aspect 78: The method according to any of the foregoing aspects, wherein further providing a laser beam to the sample.

Aspect 79: The method according to any of the foregoing aspects, wherein the needle consists of a tip having a radius of curvature of 1 nm to 1500 nm.

Aspect 80: A system for analyzing a sample, comprising: at least two needles according to claims 1 to 35 consisting of a tip, wherein the at least two needles are connected to a metal plate, and wherein the metal plate is applied an electrical potential to charge the at least two needles.

Aspect 81: A method for the detection of a disease according to any of the foregoing aspects, wherein a disease may be any illness or sickness having a specific biomarker or volatilome.

Aspect 82: A method for the detection of cancer according to any of the foregoing aspects.

Aspect 83: A method for the detection and analysis of a disease biomarker according to any of the foregoing aspects.

Aspect 84: A method for biomarker volatilome analysis according to any of the foregoing aspects.

Aspect 85: A method for fence post monitoring of at least one organic compound according to any of the foregoing aspects.

Aspect 86: A system for the detection of a disease according to any of the foregoing aspects, wherein a disease may be any illness or sickness having a specific biomarker or volatilome.

Aspect 87: A system for the detection of cancer according to any of the foregoing aspects.

Aspect 88: A system for the detection and analysis of a disease biomarker according to any of the foregoing aspects.

Aspect 89: A system for biomarker volatilome analysis according to any of the foregoing aspects.

Aspect 90: A system for fence post monitoring of at least one organic compound according to any of the foregoing aspects.

Aspect 91: A device for the detection of a disease according to any of the foregoing aspects, wherein a disease may be any illness or sickness having a specific biomarker or volatilome.

Aspect 92: A device for the detection of cancer according to any of the foregoing aspects.

Aspect 93: A device for the detection and analysis of a disease biomarker according to any of the foregoing aspects.

Aspect 94: A device for biomarker volatilome analysis according to any of the foregoing aspects.

Aspect 95: A device for fence post monitoring of at least one organic compound according to any of the foregoing aspects.

### EXAMPLES

### Example 1: Prior Art Radius of Curvature

A stainless-steel acupuncture needle known in the art, as disclosed in Habib et. al, 2013, was obtained (FIG. 2). The radius of curvature was reported in the prior art to be 350 nm according to a scanning electron microscopy image at 1000× (FIG. 3A). The same needle was examined and imaged at 16000× using scanning electron microscopy (FIG. 3B & 3C). The radius of curvature was calculated to be 1537 nm (FIG. 3B). FIG. 3C demonstrates a visual representation of a 350 nm radius of curvature superimposed on the prior art needle, demonstrating that 350 nm is not the correct radius of curvature.

### Example 2: Optimization of Needle Geometry

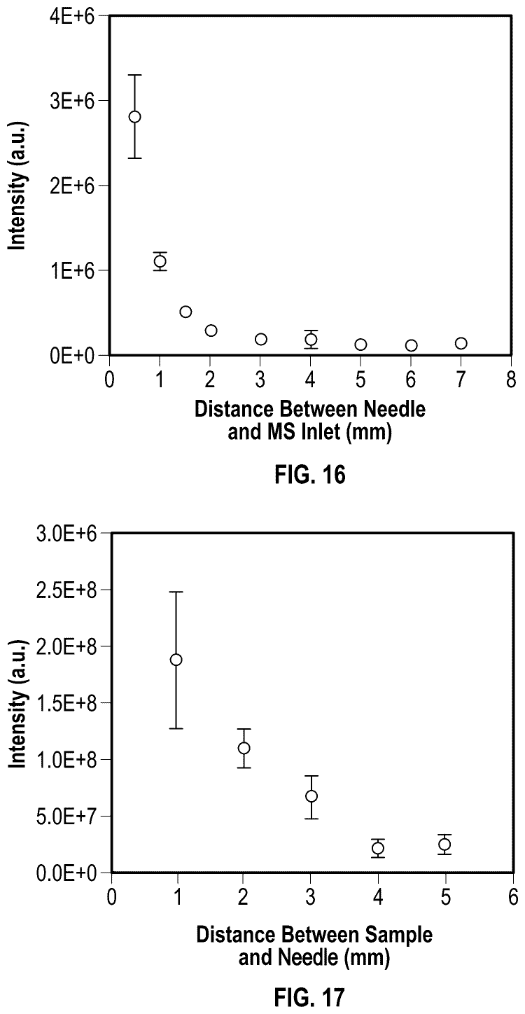

A test was performed to determine the optimal distance from the tip of the needle of the present disclosure to the mass spectrometer inlet. The needle had a radius of curvature of 18 nm, a shaft length of 4.5 cm, a shaft diameter of 254 μm, a cone base of 254 μm, a cone height of 245 μm, and a cone angle of 4.3 degrees. Optimal was determined to be the distance having the highest intensity. FIG. 16 demonstrates intensity (a.u.) vs the distance between the needle and the mass spectrometer inlet (mm). As a nonlimiting example, the optimal distance from the tip of the needle to the mass spectrometer inlet was determined to be 1 mm.

A test was performed to determine the optimal distance between a sample and the tip of the needle of the present disclosure. The needle had a radius of curvature of 18 nm, a shaft length of 4.5cm, a shaft diameter of 254 μm, a cone base of 254 μm, a cone height of 245 μm, and a cone angle of 4.3 degrees. Optimal was determined to be the distance having the highest intensity. FIG. 17 demonstrates intensity (a.u.) vs. the distance between the sample and the needle (mm). As a non-limiting example, the optimal distance from the tip of the needle to the sample was determined to be 0.5 mm.

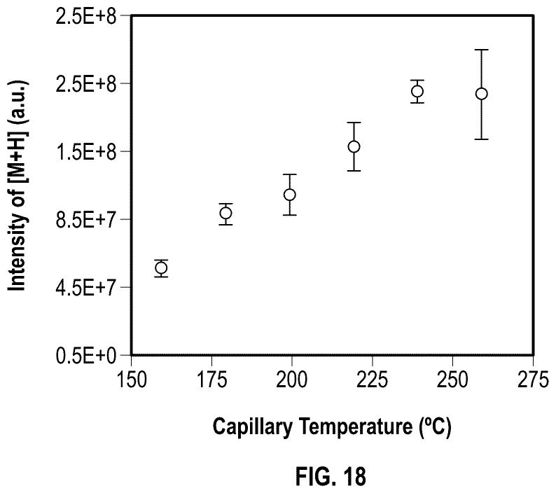

A test was performed to determine the optimal heated capillary temperature. The needle had a radius of curvature of 18 nm a shaft length of 4.5 cm, a shaft diameter of 254 μm, a cone base of 254μm, a cone height of 245 μm, and a cone angle of 4.3 degrees. Optimal was determined to be the temperature having the highest intensity. FIG. 18 demonstrates intensity (a.u.) vs. capillary temperature (° C.). As a nonlimiting example, the optimal heated capillary temperature was determined to be 240° C.

### Example 3: Continuous Use

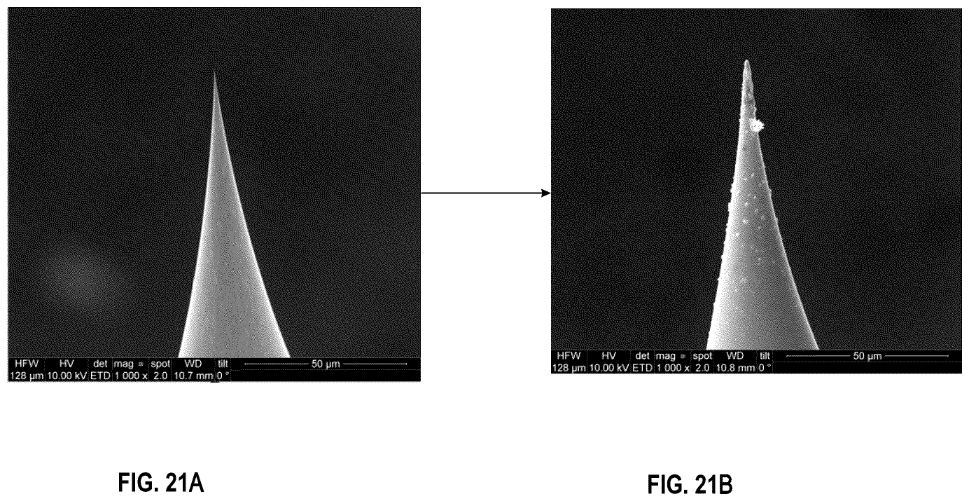

A needle of the present disclosure including tungsten and having a radius of curvature of 15 nm (FIG. 21A) was obtained. An electrical potential of 1000 V was continuously applied to the needle for 20 hours in an open system of the present disclosure, wherein an ionization region was created, and the gaseous analyte ions were collected and analyzed by a mass spectrometer. As seen in the scanning electron micrograph images, the needle did not become deformed and remained sharp (FIG. 21B).

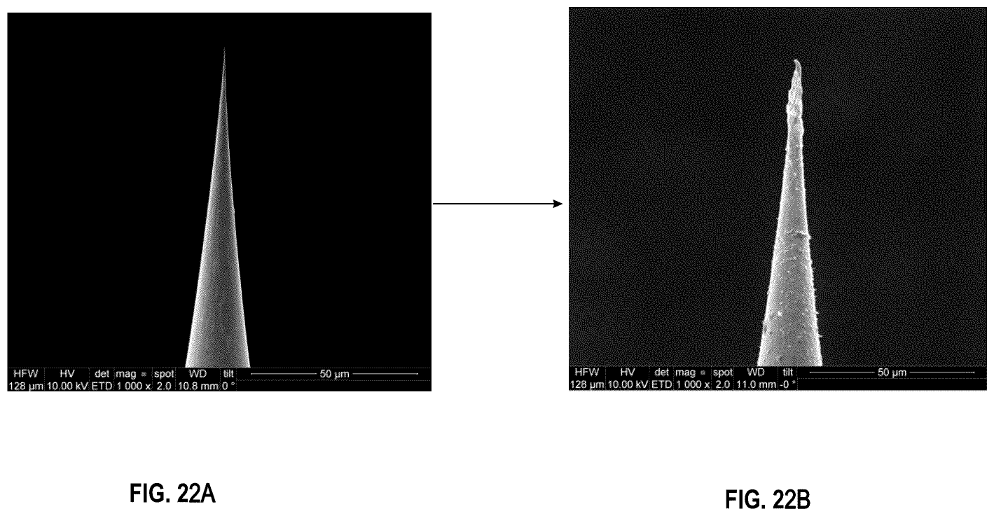

A needle of the present disclosure including tungsten and having a radius of curvature of 16 nm (FIG. 22A) was obtained. An electrical potential of 1200 V was continuously applied to the needle for 20 hours in an enclosed system of the present disclosure, wherein an ionization region was created, at the gaseous analyte ions were collected and analyzed by a mass spectrometer according to the methods of the present disclosure. As seen in the scanning electron micrograph image, the needle remained sharp (FIG. 22B).

### Example 4: Reproducible Whisker Formation

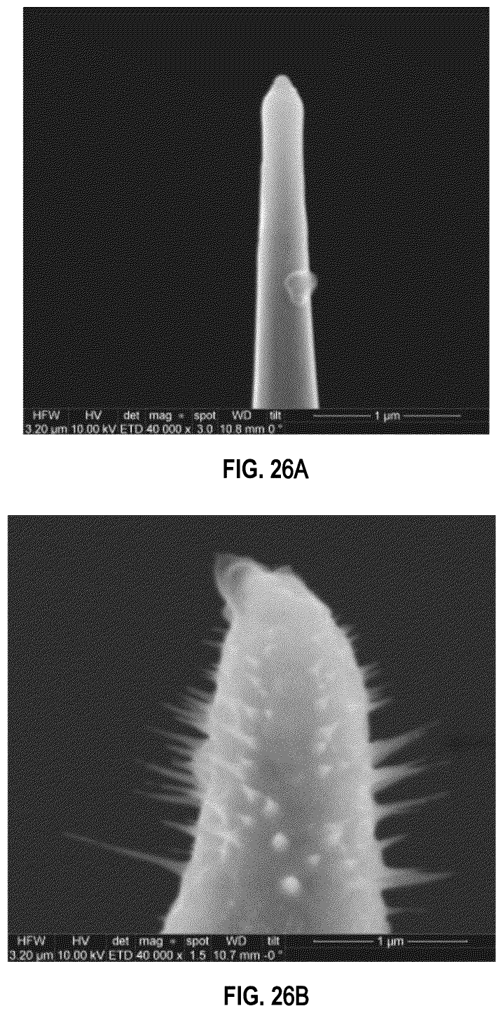

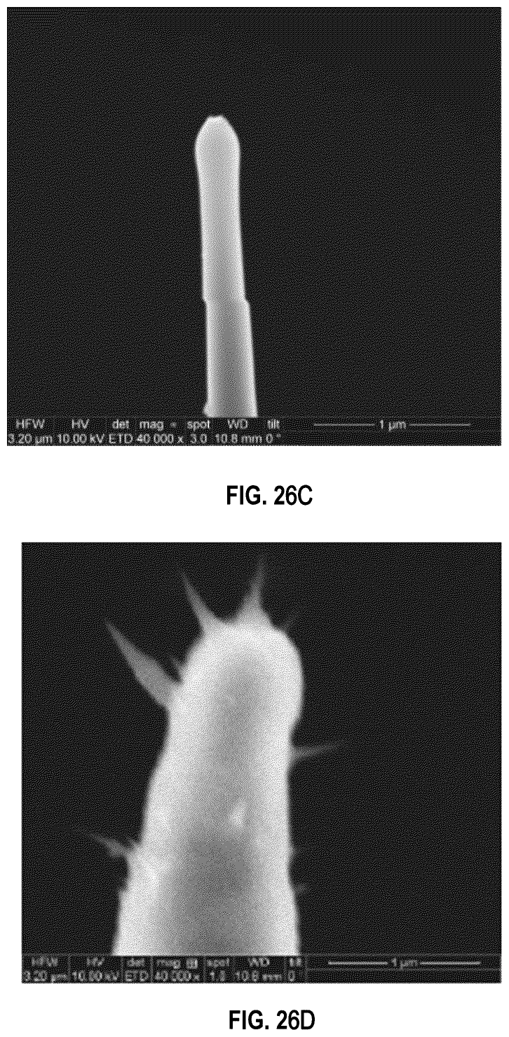

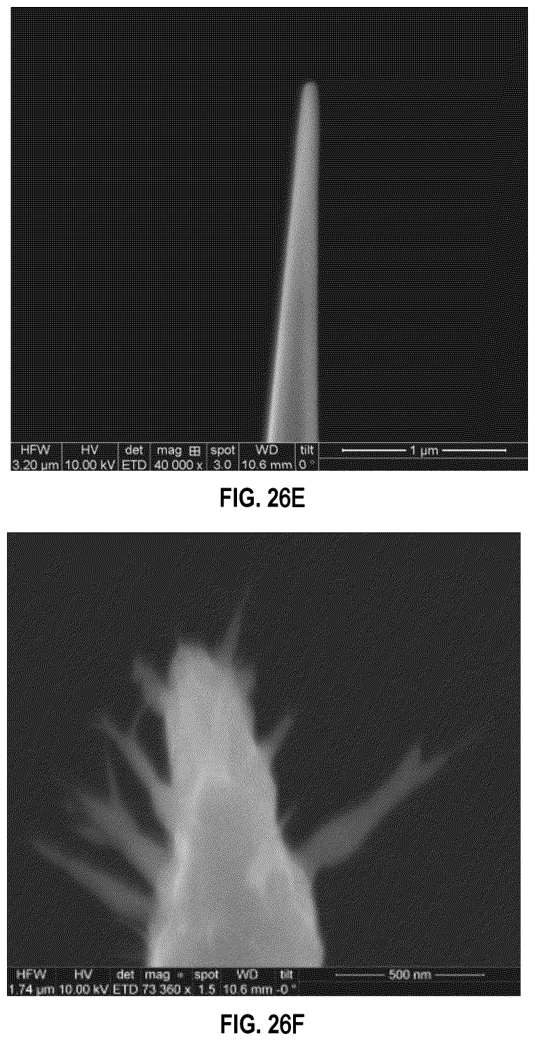

A needle of the present disclosure having a radius of curvature of 29 nm (FIG. 26A) was continuously supplied with an electrical potential of 1075 V for 20 hours. A scanning electron micrograph image was obtained at 40 k× prior to applying the electrical potential (FIG. 26A) and at 20 hours (FIG. 26B). As seen in the scanning electron micrograph image, the needle exhibited at least two whiskers and a radius of curvature of 116 nm (FIG. 26B).

A needle of the present disclosure having a radius of curvature of 44 nm (FIG. 26C) was continuously supplied with an electrical potential of 1075 V for 20 hours. A scanning electron micrograph image was obtained at 40 k× prior to applying the electrical potential (FIG. 26C) and at 20 hours (FIG. 26D). As seen in the scanning electron micrograph image, the needle exhibited at least two whiskers and a radius of curvature of 336 nm (FIG. 26D).

A needle of the present disclosure having a radius of curvature of 18 nm (FIG. 26E) was continuously supplied with an electrical potential of 1075 V for 20 hours. A scanning electron micrograph image was obtained at 40 k× prior to applying the electrical potential (FIG. 26E) and at 73,360× after 20 hours (FIG. 26F). As seen in the scanning electron micrograph image, the needle exhibited at least two whiskers and a radius of curvature of 55 nm (FIG. 26F).

### Example 5: Whisker Growth Signal Voltage

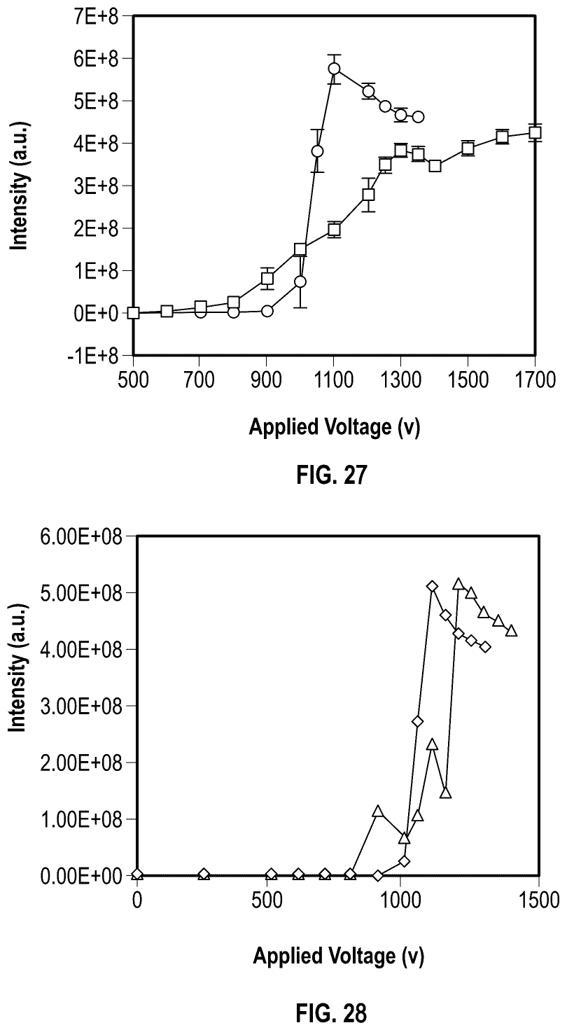

A needle of the present disclosure having a radius of curvature of 24 nm was applied a voltage of 500 V to 1400 V. The needle exhibited a signal onset voltage of about 900 V (FIG. 27 (circle)).

A needle of the present disclosure having a radius of curvature of 336 nm and at least one whisker was applied a voltage of 500 V to 1700 V. The needle exhibited a signal onset voltage of 700 (FIG. 27 (square)). Accordingly, the needle having at least one whisker had a lower signal onset voltage compared to the needle without at least one whisker, as shown in FIG. 27, wherein FIG. 27 shows intensity (a.u.) vs applied voltage (V). A second test was performed to determine the effect of whisker growth on needles having a similar radius of curvature within 10 nm.

A needle of the present disclosure having a radius of curvature of 48 nm and without at least one whisker was applied a voltage range of 0 to 1400 V. The needle exhibited a signal onset voltage of 900 V and a max intensity of around 5.00 e⁸ at 1000 V (FIG. 28 (diamond)).

A needle of the present disclosure having a radius of curvature of 55 nm and at least one whisker was applied a voltage range of 0 to 1400 V. The needle exhibited a signal onset voltage of 800 V and a max intensity of around 5.00 e⁸ at 1300 V (FIG. 28 (triangle)).

Thus, the needle having at least one whisker had a lower signal onset voltage but reached the same max intensity (FIG. 28).

### Example 6: Sample Testing

An LTQ XL mass spectrometer (Thermo Scientific, San Jose, CA, USA) was used. The settings were as follows: ion transfer tube temperature: 200° C.; ion transfer tube voltage: 50 V; tube lens: 100 V; microscans: 5; maximum ion inject time: 10 ms; scan range: 50-500 m/z; positive ion mode.

The needle tip was positioned coaxial to and within 0.5 mm of the mass spectrometer inlet. A sample was positioned approximately 1 mm from the tip of the needle. An electrical potential of 1000 V was applied using a dc power supply through a 400 MΩ. An open system was used as disclosed in FIG. 6.

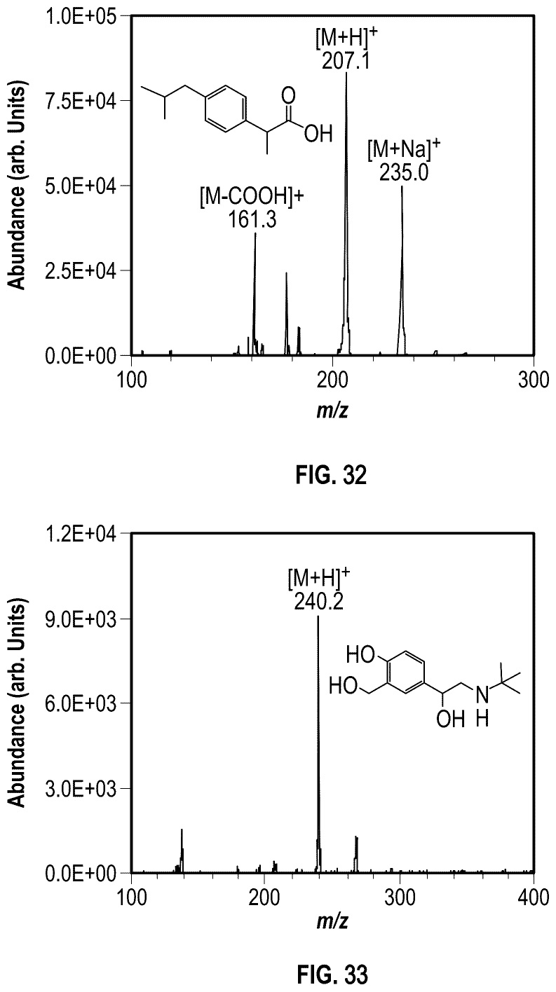

The electronical potential was applied to the needle according to the methods and open system of the present disclosure. A 200 mg tablet of ibuprofen (2-(4-isobutylphenyl) propanoic acid) held 1 mm below the tip of the needle for 5 seconds. An analysis was performed according to the methods, systems, and needle of the present disclosure, wherein a mass spectrum was produced in which the most abundant ion was [ibuprofen+H]⁺ which contained the characteristic fragment [ibuprofen-COOH]⁺ (FIG. 32).

Three puffs of an albuterol inhaler, each puff was approximately 1 second in length, were sprayed directly at the tip of the needle from three inches away. An analysis was performed according to the methods, systems, and needle of the present disclosure, wherein a mass spectrum was produced in which the most abundant ion was [albuterol+H]⁺ (FIG. 33).

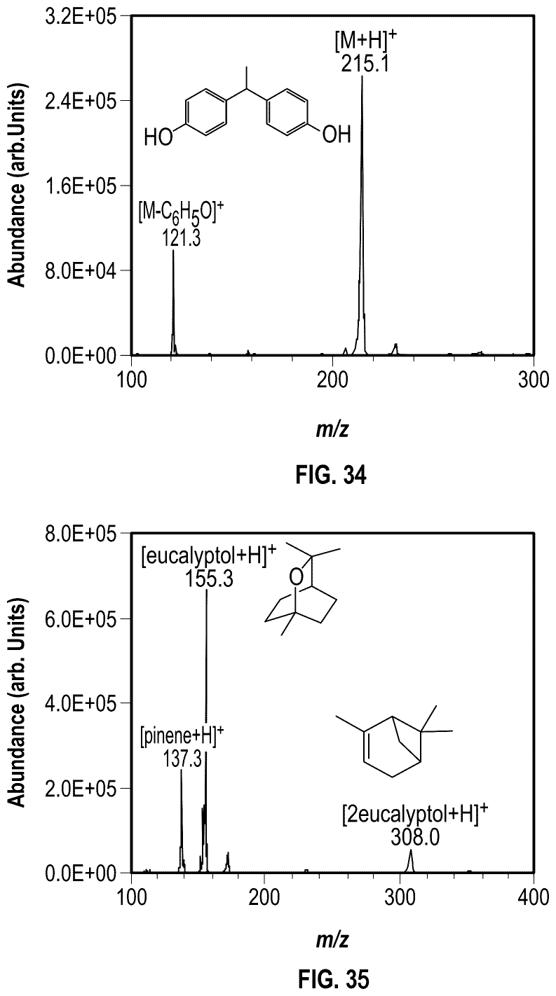

Thermal paper for receipts is conventionally coated in bisphenol A (BPA). A thermal receipt paper was held 1 mm from the tip of the needle. An analysis was performed according to the methods, systems, and needle of the present disclosure, wherein a mass spectrum was produced in which the most abundant ion was [BPE+H]⁺ (FIG. 34).

The aromatic profile of peppermint essential oil was analyzed using the methods, systems, and needle of the present disclosure. A vial of peppermint essential oil was opened six inches underneath the tip of the needle. An analysis was performed according to the methods, systems, and needle of the present disclosure, wherein a mass spectrum was produced in which the most abundant ion was [eucalyptol+H]⁺ followed by [pinene+H]⁺ (FIG. 35).

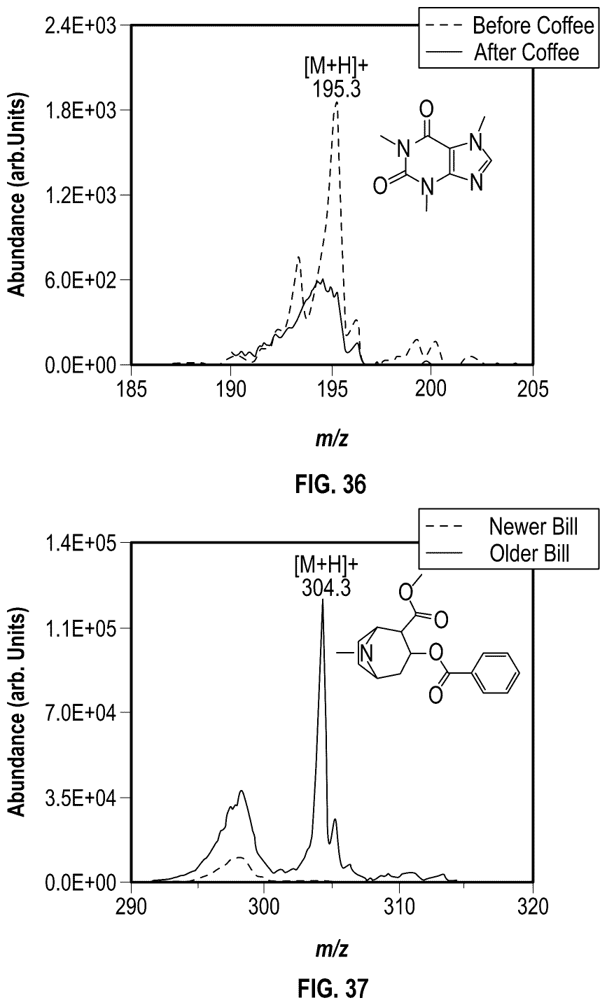

The methods, systems, and needle of the present disclosure were utilized to detect a drug in trace quantities from a surface. An ungloved human finger was held 1 mm from the tip of the needle. The human subject had not consumed caffeine for at least 24 hours. A first analysis was performed according to the methods, systems, and needle of the present disclosure, wherein a mass spectrum was produced, and caffeine was not clearly detected (FIG. 36). Immediately after the first m/z analysis, the human subject drank about 230 mL of coffee. After 20 minutes, the subject's same finger was held 1 mm from the tip of the needle in the same location. A second analysis was performed according to the methods, systems, and needle of the present disclosure, wherein a mass spectrum was produced in which the most abundant ion was [caffeine+H]⁺ (FIG. 36).

The edge of two randomly selected $5 denominations of U.S. paper currency were separately held 1 mm from the tip of the needle. One bill had been in circulation longer than the bill that was more recently printed. An analysis was performed according to the methods, systems, and needle of the present disclosure for each bill, wherein a mass spectrum was produced in which the most abundant ion was [cocaine+H]⁺ for a bill that had been in circulation longer than a bill that was more recently printed (FIG. 37).

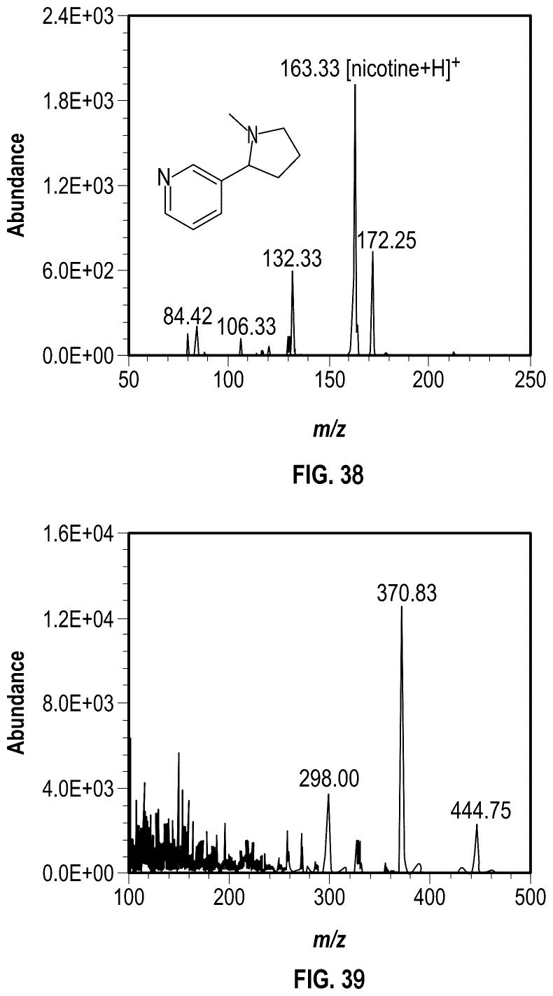

Using an enclosed system as detailed in FIG. 8, a nicotine commercial e-cigarette was analyzed. The e-cigarette mouthpiece was connected to the sniffing tube, and the suction pulled by the mass spectrometer extracted volatiles from the e-cigarette's interior. An analysis was performed according to the methods, systems, and needle of the present disclosure, wherein a mass spectrum was produced in which the most abundant ion was [nicotine+H]⁺ (FIG. 38).

As a control, a background air spectrum was performed by providing an electrical potential to the needle and collected any ionized gaseous analytes that may be present in the background air. The background air spectrum is shown in FIG. 39.

### Example 7: Needle Geometry

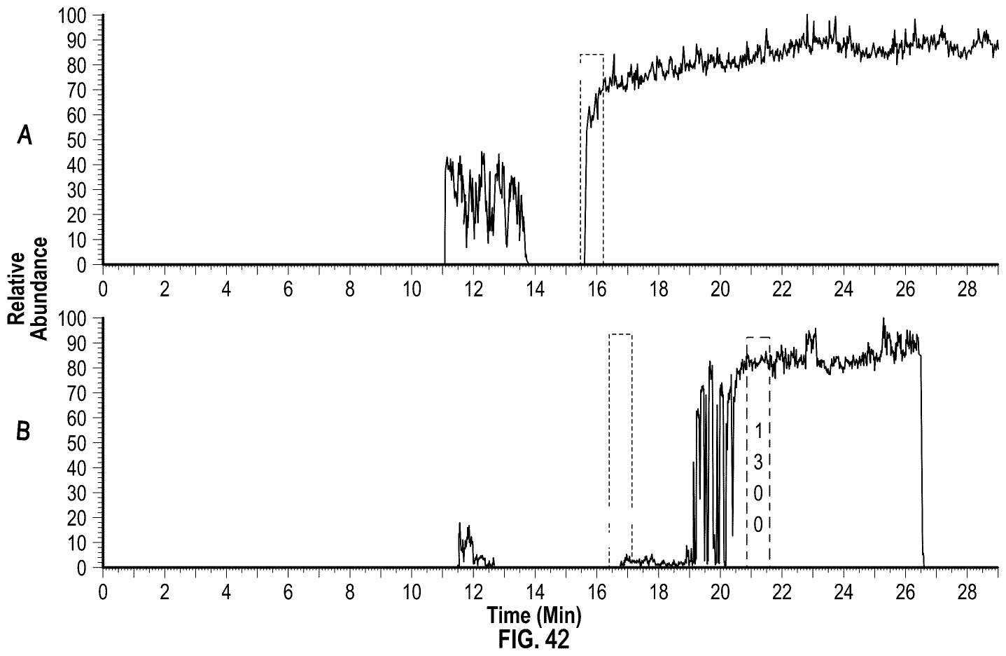

Voltage titration experiments were conducted in which voltage applied to the needle of the present disclosure was continuously increased from approximately 0 V to 2000 V, and the resulting signal was monitored via total ion chromatogram (TIC). The experiment was conducted for a needle placed coaxial with the inlet of the mass spectrometer (FIG. 42A) and for a needle placed perpendicular to the inlet of the mass spectrometer (FIG. 42B). Coaxial geometry allowed for a sufficient signal at 1000 V (dashed box), while a perpendicular geometry required 1300 V to achieve the same signal.

### Example 8: Needle Reusability

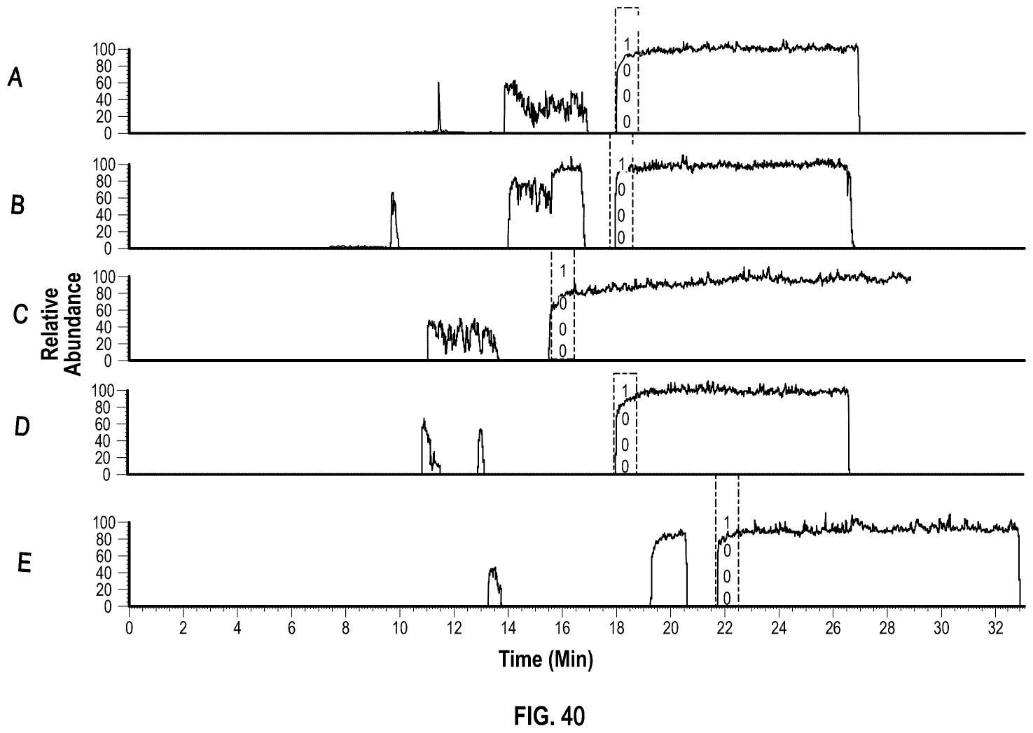

Voltage titration experiments were conducted using needles of the present disclosure having a different radius of curvature to determine needle reusability, wherein the voltage was increased overtime from approximately 0 V to 2000 V. Needles having a radius of curvature of 13 nm, 18 nm, 32 nm, 42 nm, and 52 nm were applied a continuously increasing voltage and the resulting signal in V (dashed box) was monitored via TIC. The results are shown in FIGS. 40A, 40B, 40C, 40D, and 40E, respectively. All needles achieved a stable discharge by 1000 V.

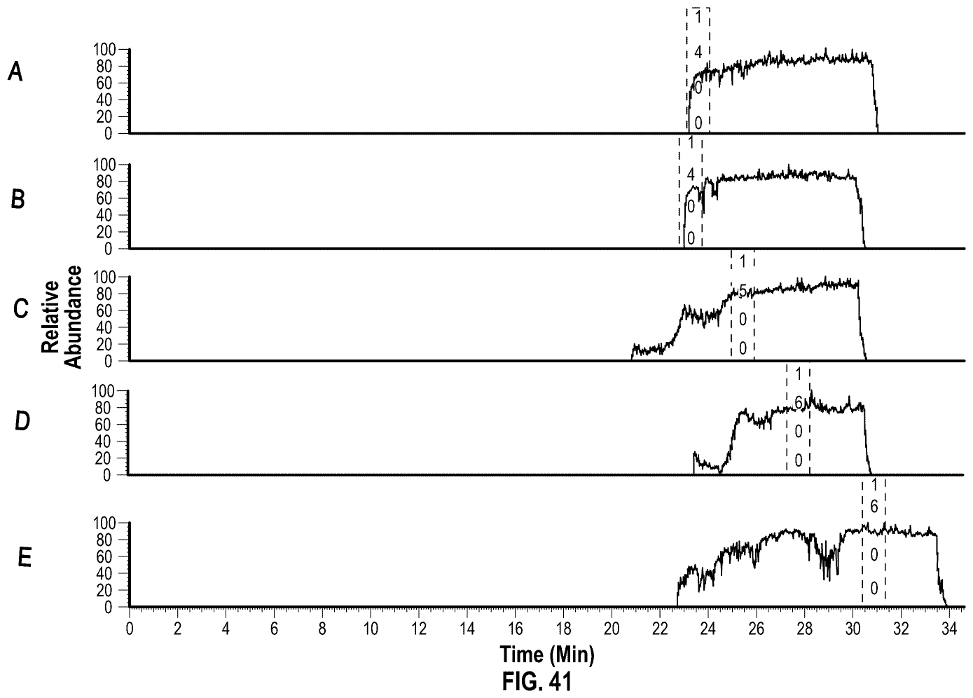

The needles became duller after the first titration. Thus, the radius of curvature changed to 215 nm, 62 nm, 65 nm, 197 nm, and 317 nm, respectively. A second voltage titration was performed wherein the needles were applied a continuously increasing voltage over time from approximately 0 V to 2000 V, and the resulting signal was monitored via TIC. The results are shown in FIGS. 41A, 41B, 41C, 41D, and 41E, respectively. All needles achieved a stable discharge by 1600 V (dashed box).

After a second use, the needles had a radius of curvature of 216 nm, 70 nm, 68 nm, 198 nm, and 406 nm, respectively.

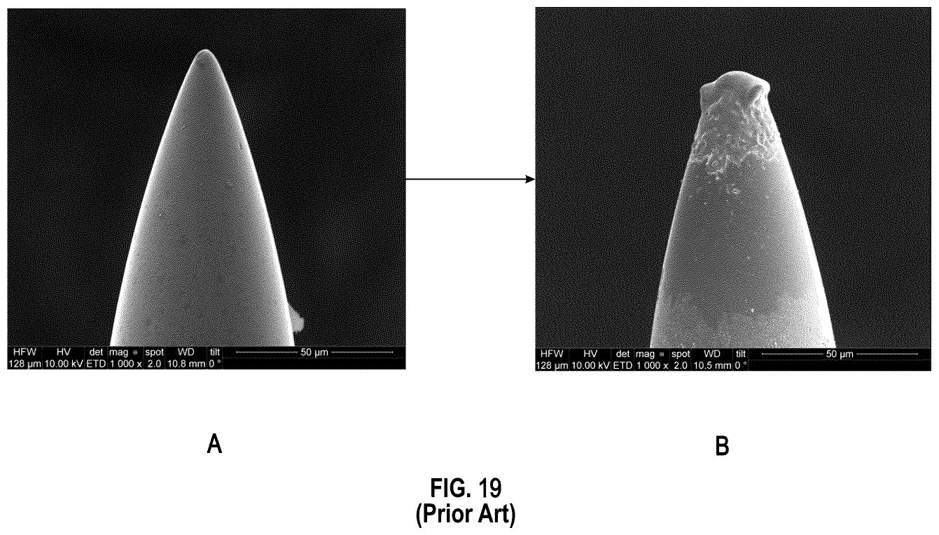

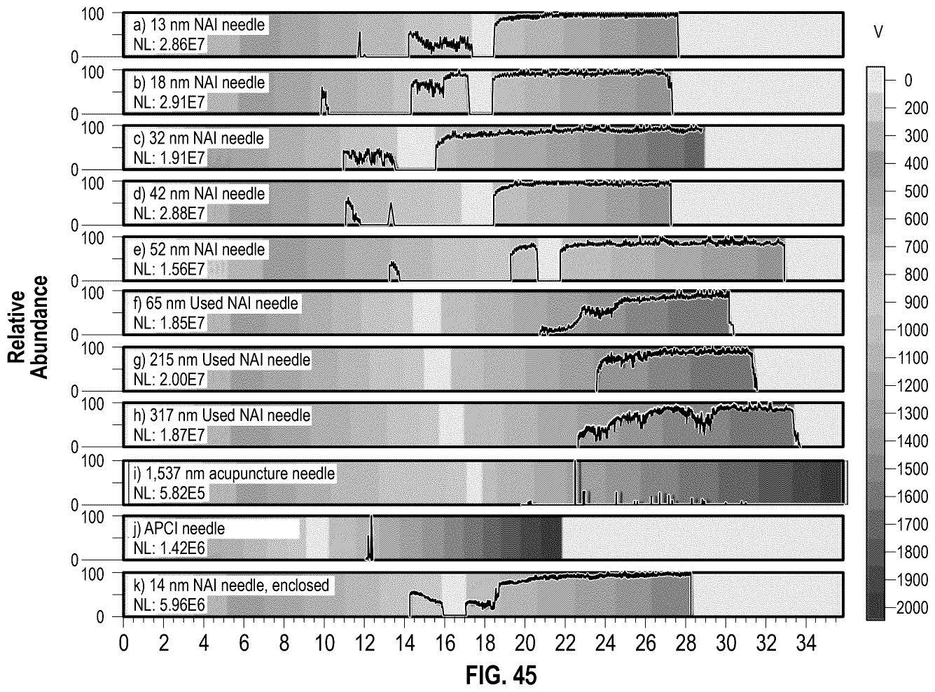

A voltage titration experiment was conducted using needles known in the art. A stainless-steel acupuncture needle known in the art, as disclosed in Habib et. al, 2013, was obtained and imaged at 1000× magnification using a scanning electron microscope (FIG. 19A), wherein the needle had a radius of curvature of 1537 nm. The needle was applied a continuously increasing voltage from approximately 0 V to 2000 V. The resulting signal was monitored by TIC. The results are shown in FIG. 45 panel I. The needle did not achieve a stable discharge up to 2000 V. The needle became deformed after use (FIG. 19B) with a radius of curvature of 9,640 nm after the titration.

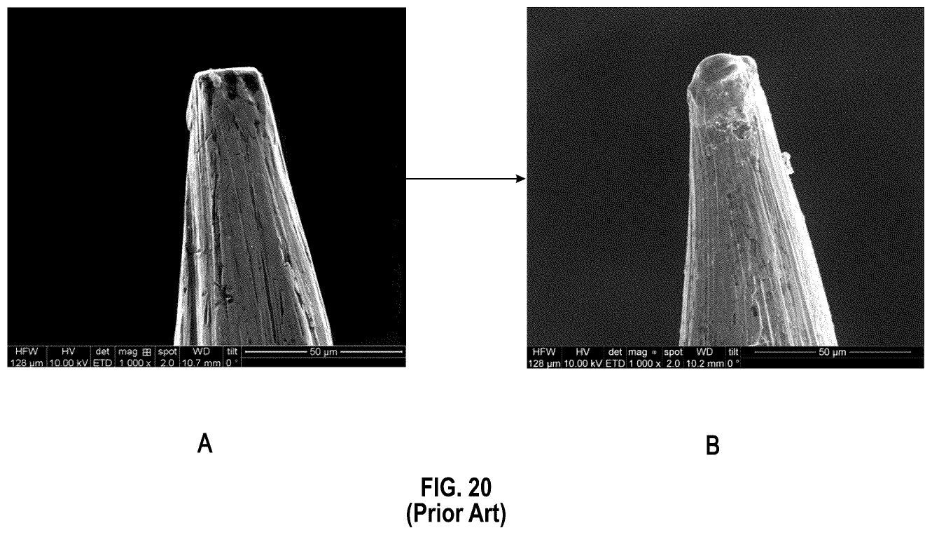

A Voltage titration experiment was conducted using a standard Atmospheric Pressure Chemical Ionization (ACPI) needle known in the art (FIGS. 1 & 20A). The needle was applied a continuously increasing voltage from approximately 0 V to 2000 V. The resulting signal was monitored by TIC. The results are shown in FIG. 45 panel J. The needle did not achieve a stable discharge up to 2000 V. The needle became deformed after use (FIG. 20B) with a radius of curvature of 10,360 nm.

The needles of the present disclosure achieved a stable discharge at a voltage less than 2000V on even their second use compared to the needles known in the art, which did not achieve a stable discharge up to 2000 V on their first use.

### Example 9: Resistor Testing

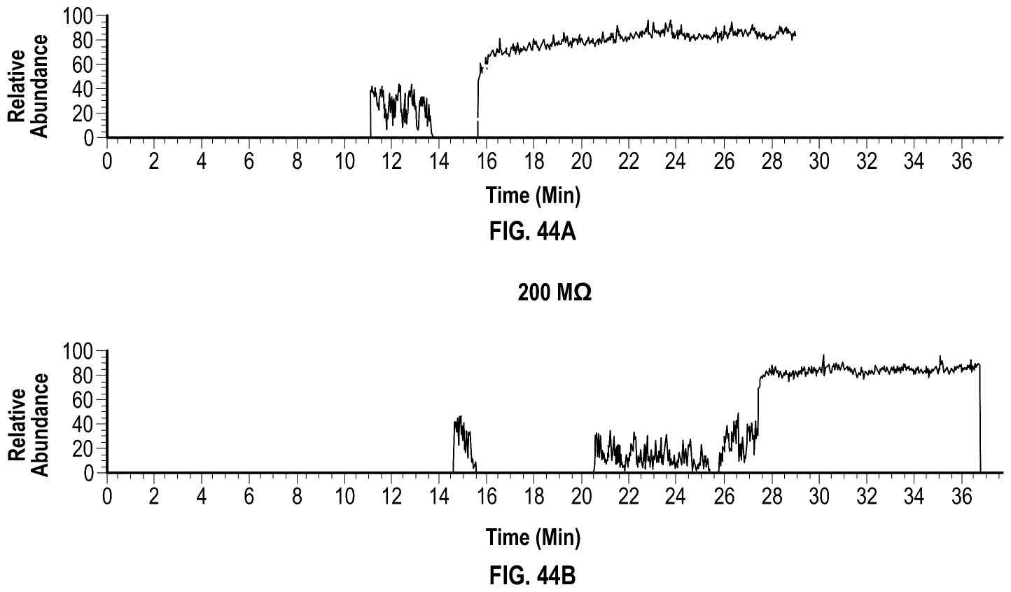

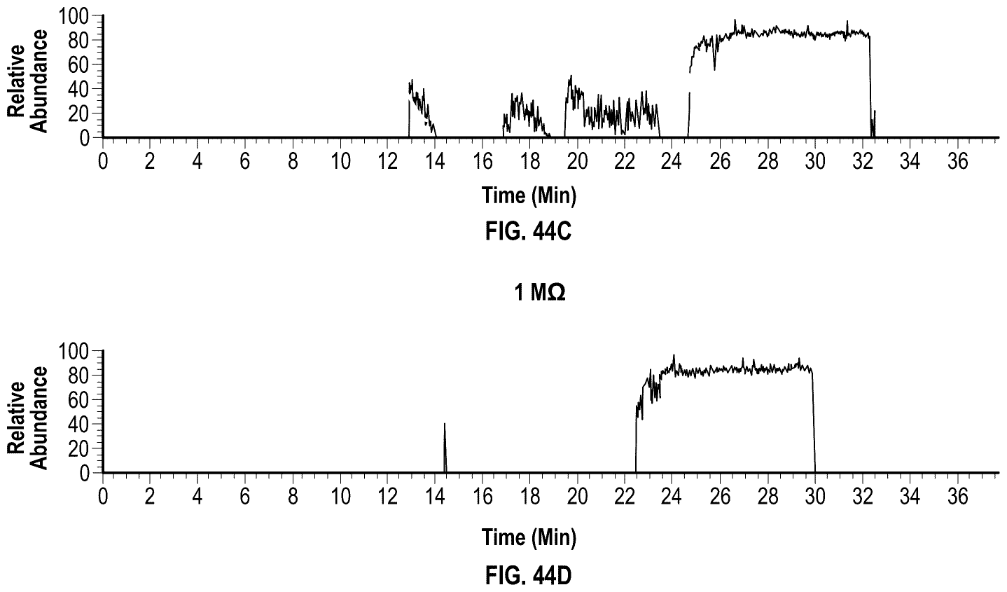

Voltage titrations were conducted using 1, 22, 200 and 400 MΩ resistors in an open system, wherein maximum signal intensity and the voltage at which the signal plateaus (indicating stable corona discharge formation) were independent of resistance within the range of 1 to 400 MΩ. Resistance was correlated with signal stability and arcing. The 400 MΩ resistor produced a stable signal at 1000 V and suppressed arcing while maintaining a stable signal through 1700 V (FIG. 44A). The other resistances had more signal variation at 1000 V, with 200 MΩ not achieving stability until 1200 V (FIG. 44B). The 200 (FIG. 44B) and 22 MΩ (FIG. 44C) resistors arced at 1500 and 1400 V, respectively. The 1 MΩ (FIG. 44D) set up was expected to arc, but the voltage titration was stopped at 1200 V for the protection of the instrument. The needle using the 400 MΩ resistor remained sharp after the voltage titration, wherein the needles of the other resistors became dull.

### Example 10: Voltage Titrations

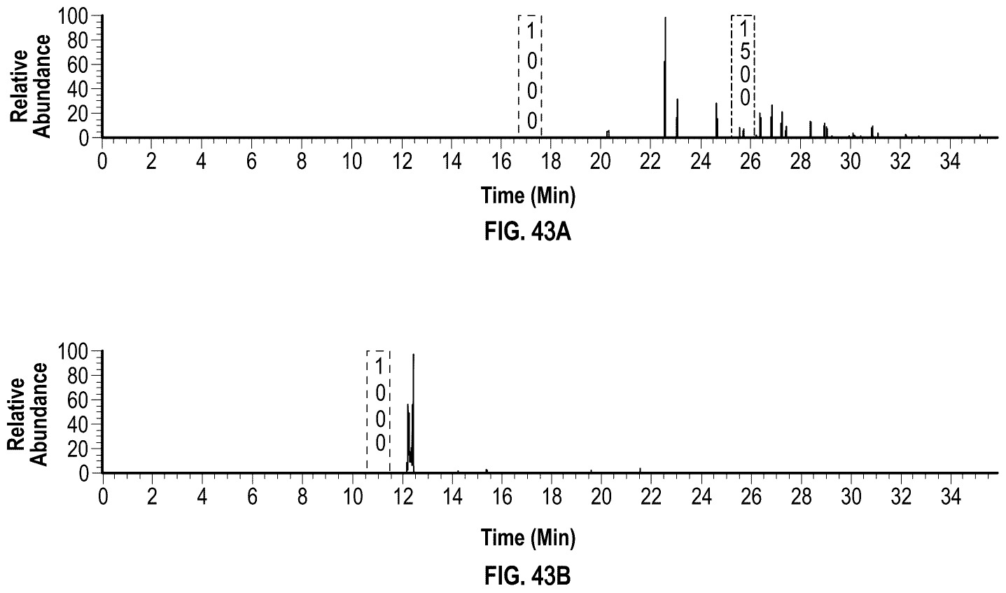

Voltage titrations were performed on unused needles of the present disclosure having a radius of curvature of 13, 18, 32, 42, and 52 nm and used needles having a radius of curvature of 65, 215, and 317 nm. Each needle was applied a continuously increasing voltage up to 2000 V in an open system of the present disclosure, and the resulting signal was monitored by TIC. Needles having a radius of curvature of 13, 18, 32, 42, and 52 formed a stable ionization region at 1000 V, as show in FIG. 45 panels A-E. Needles having a radius of curvature of 65 and 215 nm formed a stable ionization region at 1500 V (FIG. 45 panels F & G), and the needle having a radius of curvature of 317 nm formed a stable ionization region at 1600 V (FIG. 45 panel H). As shown in FIG. 45 & FIG. 43, neither the approximately 1537 nm radius of curvature acupuncture needle of FIG. 2 (FIG. 45 panel I & FIG. 43A) or the APCI needle known in the art (FIG. 45 panel J & FIG. 43B) produced a stable ionization region within the range of 0 to 2000 V.

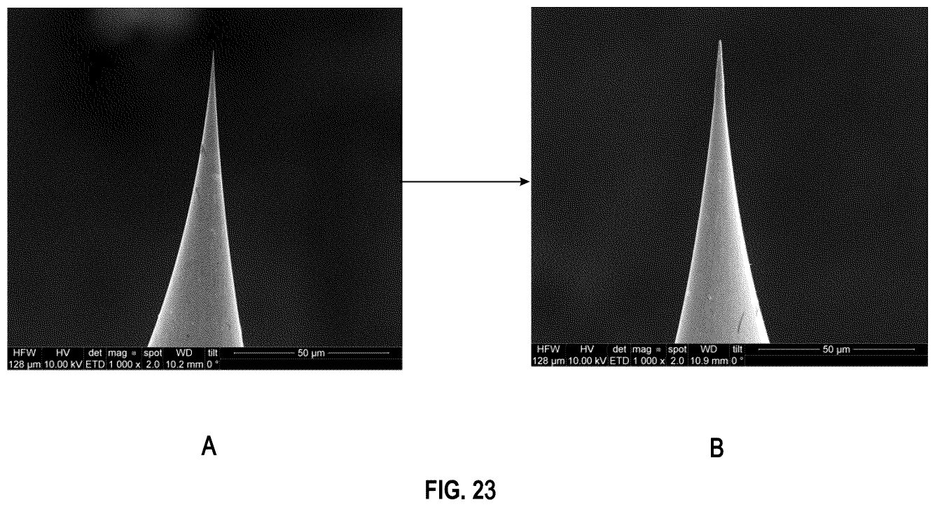

FIG. 23A is a scanning electron microscopy image at 1000× magnification of the needle of FIG. 45 panel A, wherein FIG. 23B is a scanning electron microscopy image of the same needle at 1000× magnification having a radius of curvature of 215 nm after the voltage titration. A voltage titration was also performed on a needle of the present disclosure having a radius of curvature of 14 nm in an enclosed system. The needle achieved a stable ionization region at 1200 V, as shown in FIG. 45 panel K.

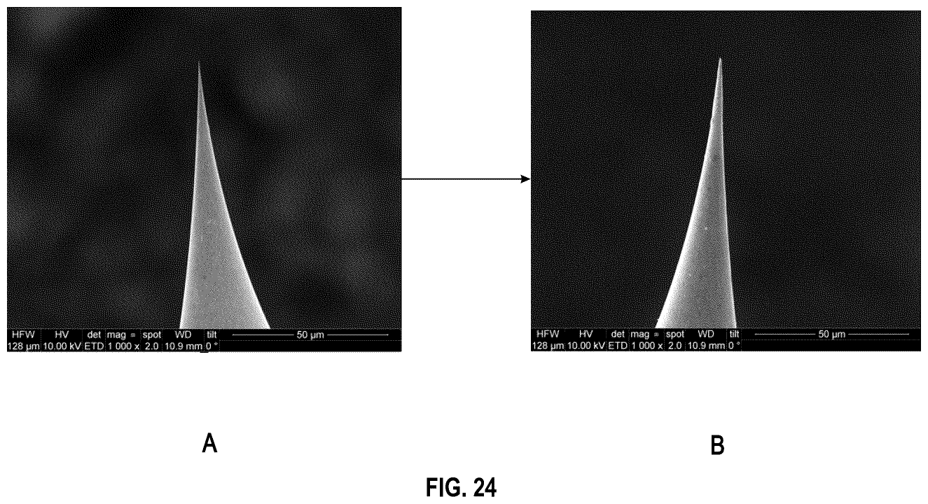

FIG. 24A is a scanning electron microscopy image at 1000× magnification of the needle of FIG. 45 panel K, wherein FIG. 24B is a scanning electron microscopy image of the same needle at 1000× magnification having a radius of curvature of 51 nm after the voltage titration.

### Example 11: Continuous Signal Monitoring

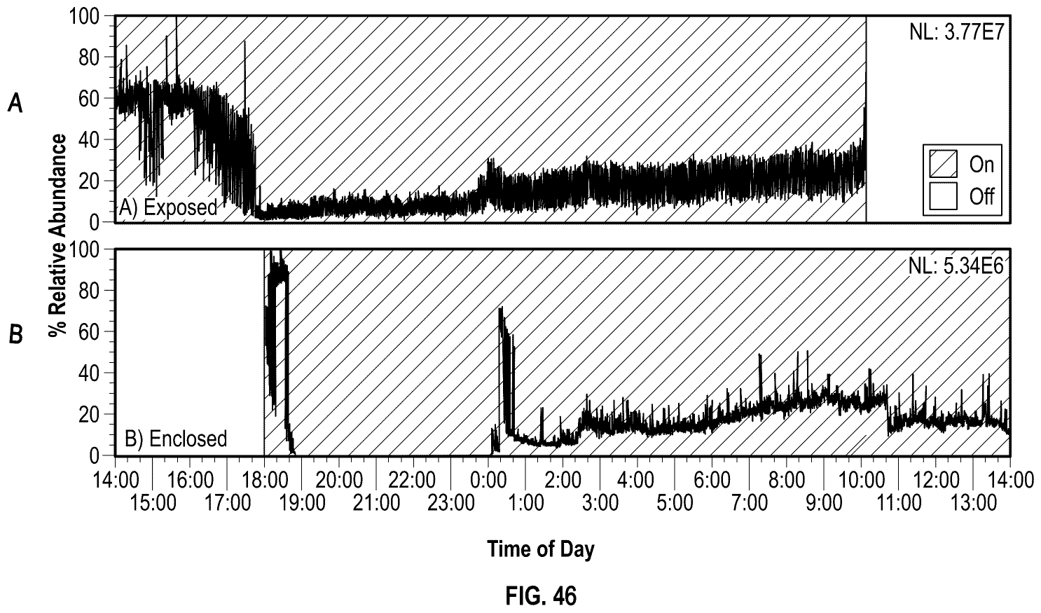

An open system of the present disclosure and an enclosed system of the present disclosure continuously collected a signal for 20 hours. The open system produced a noisier signal compared to the enclosed system due to air movement in the room. The open system and enclosed system were started at 2:00 PM and 6:00 PM, respectively. The resulting TICs are demonstrated in FIG. 46A for the open system and FIG. 46B for the enclosed system.

Both the open system and the closed system exhibited a high signal until a drop off at 6 PM/7 PM followed by low signal until midnight, wherein the signal steadily rose until 10 AM with a small spike a 2:30 AM. The cause of signal changes was likely due to changes in the air such as an air conditioning turning on/off, a person passing by, etc.

### Example 12: Detection of a Biomarker for Parkinson's Disease

Perillic aldehyde is a known biomarker for Parkinson's disease. A system of the present disclosure having a needle of the present disclosure was used to qualitatively analyze a sample of perillic aldehyde. The system included a T-connection and a sample collection tube, wherein the sample was a piece of gauze having one drop of perillic aldehyde.

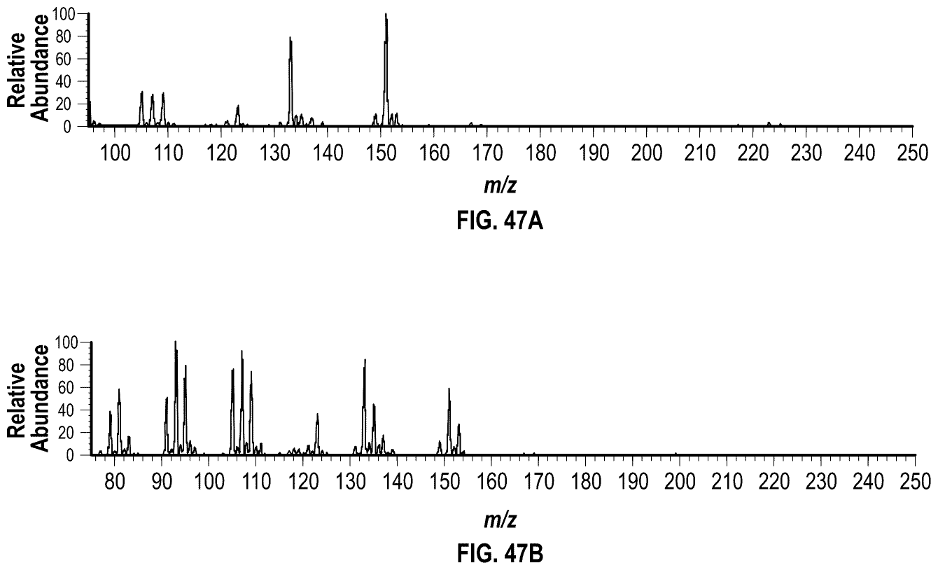

FIG. 47A shows a mass spectrum of a perillic aldehyde standard as a control.

FIG. 47B shows a mass spectrum of one drop of perillic aldehyde analyzed by the methods, system, and needle of the present disclosure, wherein the methods, system, and needle of the present disclosure were able to accurately perform a qualitative analysis on the perillic aldehyde biomarker for Parkinson's disease.

### REFERENCES

Habib, A.; Usmanov, D.; Ninomiya, S.; Chen, L. C.; Hiraoka, K. Alternating Current Corona Discharge/Atmospheric Pressure Chemical Ionization for Mass Spectrometry. Rapid Communications in Mass Spectrometry 2013, 27 (24), 2760-2766. https://doi.org/10.1002/RCM.6744.

1.-89. (canceled)

90. A needle for mass spectrometry, comprising:
a solid shaft; and
a first end with a tip having a radius of curvature of less than 800 nm,
wherein the tip is distal from a second end of the needle, the tip having a cone height of less than 1000 microns, and the tip having a length of 0.001 cm to 2.5 cm, wherein the second end is configured to accept an electrical potential of 10 kV or less, and wherein the tip provides an ionization region when the electrical potential is applied.

91. The needle of claim 90, wherein the tip is tapered.

92. The needle of claim 90, wherein the radius of curvature is less than 1 nm.

93. The needle of claim 90, wherein a cone angle of the tip is 1 degree to 90 degrees.

94. The needle of claim 90, wherein a cone base of the tip is 0.1 mm to 3 mm.

95. The needle of claim 90, wherein the tip comprises at least two whiskers.

96. The needle of claim 90, wherein the needle has an aspect ratio of 2:1 to 1:50 or 1:1, wherein the aspect ratio comprises a ratio of a shaft diameter to a tip height.

97. The needle of claim 90, wherein the needle is comprised of a material selected from tungsten, gold, platinum, titanium, stainless steel, conductive non-metal material, ceramic material coated with a metal, and a conductive polymeric material.

98. The needle of claim 90, wherein the radius of curvature is determined by drawing a circle to follow the curvature of an apex of the tip using a scanning electron micrograph image of at least 300× magnification, calculating an area of the circle, and calculating the radius of curvature from the area.

99. A method of manufacturing a needle of claim 90, the method comprising:
inserting an end of a metal wire through a center of a conductive annular ring and into a crucible containing a salt solution; and
applying a voltage,
wherein the center of the conductive annular ring comprises a liquid lamella comprising a metal hydroxide.

100. A method for detecting at least one analyte, the method comprising the steps of:
providing an electrical potential to the needle of claim 90, wherein the electrical potential causes an ionization region at the tip to convert the at least one analyte of a sample to at least one gaseous analyte ion;
collecting the at least one gaseous analyte ion into an inlet of a mass spectrometer, wherein the tip of the needle is 0.1 mm to 15000 mm from the inlet; and
analyzing the at least one gaseous analyte ion using a mass spectrometer, wherein analyzing comprises a qualitative or quantitative analysis, wherein qualitative analysis comprises determining a presence or an absence of at least one chemical component or at least one analyte in the sample, and wherein quantitative analysis comprises determining an amount of at least one chemical component or at least one analyte in the sample.

101. The method of claim 100, wherein the sample is selected from a group consisting of: a drug, an inorganic compound, an organic compound, human tissue, exhaled breath, and a volatile or semi-volatile organic compound.

102. A method for mass spectrometer imaging of an inorganic surface or an organic surface, comprising:
providing an electrical potential to a first needle of claim 90, wherein the electrical potential causes an ionization region at the tip of the first needle to convert at least one analyte of an inorganic or organic sample to at least one gaseous analyte ion;
collecting the at least one gaseous analyte ion via a transfer tube, wherein the transfer tube is connected to a second needle of claim 90, wherein a second electrical potential is applied to the second needle, wherein the electrical potential causes an ionization region at the tip of the second needle to convert at least one analyte to at least one gaseous analyte ion; and
analyzing the at least one gaseous analyte ion using a mass spectrometer, wherein analyzing comprises a qualitative or quantitative analysis.

103. The method of claim 102, wherein further providing a laser beam to the sample.

104. The method of claim 102, wherein heat is applied to the surface of the sample to provide improved spatial resolution for imaging.

105. An open system for detection of at least one analyte of a sample, the system comprising:
a device adapted to apply an electrical potential of 1 kV to 10 kV to a needle with a tip having a radius of curvature of less than 800 nm, wherein the electrical potential causes an ionization region at the tip to convert the at least one analyte to at least one gaseous analyte ion;
a mass spectrometer inlet spaced 0.01 mm to 15000 mm from the tip of the needle,
wherein the inlet is adapted to collect the at least one gaseous analyte; and
a mass spectrometer configured to qualitatively analyze the at least one gaseous analyte ion.

106. The system of claim 105, further comprising a conduit to transport the sample to the ionization region.

107. The system of claim 105, further comprising at least two needles with a tip having a radius of curvature of less than 800 nm in a serial, parallel, or serial and parallel configuration.

108. An enclosed system for detection of at least one analyte, the system comprising:
a device adapted to apply an electrical potential of 1 kV to 10 kV to an encased needle with a tip having a radius of curvature of less than 350 nm, wherein the electrical potential causes an ionization region at the tip to convert the at least one analyte to at least one gaseous analyte ion;
a mass spectrometer inlet spaced 0.01 mm to 15000 mm from the tip of the needle, wherein the inlet is adapted to collect the at least one gaseous analyte; and
a mass spectrometer configured to qualitatively analyze the at least one gaseous analyte.

109. The system of claim 108, further comprising at least two needles with a tip having a radius of curvature of less than 800 nm in a serial, parallel, or serial and parallel configuration.
